(19) United States
(12) Patent Application Publication
(10) Pub. No.: US 2026/0030550 A1
(43) Pub. Date: Jan. 29, 2026

(54) PRE-TRAINING METHOD AND SYSTEM FOR MULTI-TASKING MODEL

(71) Applicant: LG MANAGEMENT DEVELOPMENT INSTITUTE CO., LTD., Seoul (KR)

(72) Inventors: Dae Woong JEONG, Seoul (KR); Sung Moon KO, Gyeonggi-do (KR); Su Min LEE, Seoul (KR); Hyun Seung KIM, Seoul (KR); Soo Rin YIM, Seoul (KR); Chan Hui LEE, Seoul (KR); Se Hui HAN, Seoul (KR)

(21) Appl. No.: 19/280,499

(22) Filed: Jul. 25, 2025

(30) Foreign Application Priority Data
Jul. 25, 2024 (KR) 10-2024-0098936

(51) Int. Cl. G06N 20/00

(52) U.S. Cl. CPC G06N 20/00

(57) ABSTRACT

A method for performing pre-training for a multi-tasking model includes: acquiring experimental data including material-specific characteristic information, which is information specifying unique characteristics of a predetermined material, and material-physical property specific information, which is information specifying characteristic values for a plurality of physical properties of the material; simultaneously training a plurality of tasks for predicting the characteristic values for the plurality of physical properties based on the acquired experimental data in the multi-tasking model; and providing the trained multi-tasking model. The simultaneous training of the plurality of tasks includes simultaneously training the plurality of tasks based on a plurality of task processing units, each including a task processing unit configured to process a plurality of sub-tasks for predicting a characteristic value for each physical property.

### CROSS-REFERENCE TO RELATED APPLICATION

This application claims the benefit of and priority to Korean Patent Application No. 10-2024-0098936, filed on Jul. 25, 2024, the entire disclosure(s) of which is hereby incorporated herein by reference in its entirety.

### BACKGROUND

### Field

The present disclosure generally relates to a pre-training method and system for a multi-tasking model. More specifically, some embodiments of the present disclosure relate to a pre-training method and system for a multi-tasking model that perform transfer learning through geometric alignment in an integrated latent space for multiple tasks according to a plurality of domains.

### Description of Related Art

Machine learning and artificial intelligence models require large amounts of data. However, there are limitations in having sufficient data. Especially when trying to apply models to new domains or tasks more data is needed for the machine learning and artificial intelligence models. An example is a molecular structure data set. In the fields of chemistry and pharmacy, data is needed to predict the properties of new molecules, but experimental data for each molecule may be difficult to acquire and costs a lot of money. Therefore, the need for a transfer learning technique that applies knowledge from already trained models to new tasks has increased.

However, existing transfer learning has been mainly developed focusing on classification problems of large-scale data sets such as image or text data. Therefore, existing transfer learning techniques show limitations when applied to small-scale, complex data sets such as regression problems or molecular data sets. In particular, since molecular structure data is high-dimensional and the relationship between each composition and bond greatly affects each physical property, when the transfer learning technique is applied to the relationship between other physical properties and molecular structure data after training the relationship between one physical property and molecular structure data, existing Euclidean space-based transfer learning techniques cannot effectively handle such complex structures in non-Euclidean space.

Meanwhile, Riemannian geometry enables calculus in curved space, which allows for better representation and analysis of complex data structures. This Riemannian geometry approach assumes that latent vectors exist on a curved manifold, which is advantageous in aligning the geometry between complex source and target tasks.

Therefore, based on the above background, it is necessary to introduce a new technology that demonstrates high prediction performance and stability even in small data sets, implements more effective transfer learning, and improves model normalization performance to enhance generalization performance.

### SUMMARY

One embodiment of the present disclosure provides a pre-training method and system for a multi-tasking model that performs transfer learning through geometric alignment in an integrated latent space for multiple tasks according to a plurality of domains.

In addition, one embodiment of the present disclosure provides a pre-training method and system for a multi-tasking model that simultaneously train various prediction tasks according to the plurality of domains in the transfer learning process, thereby training not only individual principles of each domain but also correlations between domains and common principles for the entire domain.

In addition, one embodiment of the present disclosure provides a pre-training method and system for a multi-tasking model that implement exchange of mutual information by matching geometric properties between various prediction tasks.

In addition, one embodiment of the present disclosure provides a pre-training method and system for a multi-tasking model that secure a data set for training by utilizing source data from various sources.

In addition, one embodiment of the present disclosure applies the multi-tasking learning model trained as above to predict relationships between a plurality of physical properties and materials, thereby providing a multi-tasking model capable of predicting the physical properties for a specific material and predicting a specific material satisfying the plurality of physical properties.

However, the technical problems to be solved by the present disclosure and embodiments of the present disclosure are not limited to the technical problems described above, and other technical problems may exist.

A pre-training method for a multi-tasking model according to an embodiment of the present disclosure relates to a method for performing pre-training for a multi-tasking model by a computing system including a memory and a processor, the method including: acquiring experimental data including material-specific characteristic information, which is information specifying unique characteristics of a predetermined material, and material-physical property specific information, which is information specifying characteristic values that the material has for a plurality of physical properties; simultaneously training a multi-tasking model to perform a plurality of tasks for predicting the characteristic value for each of the plurality of physical properties based on the acquired experimental data; and providing the trained multi-tasking model, in which the simultaneous training of the plurality of tasks includes simultaneously training the plurality of tasks based on a plurality of task processing units including a first task processing unit, which is a module for processing a plurality of sub-tasks for predicting a characteristic value for a first physical property, a second task processing unit, which is a module for processing a plurality of sub-tasks for predicting a characteristic value for a second physical property, and an nth task processing unit, which is a module for processing a plurality of sub-tasks for predicting a characteristic value for an nth (n>=2) physical property.

In another aspect, the task processing unit includes an encoder module which is a module that maps a feature vector of a predetermined first task to a first latent space corresponding to the first task, a transfer module which is a module that maps the feature vector of the first task mapped to the first latent space to a second latent space corresponding to a predetermined second task through an integrated latent space shared by the plurality of tasks, and an inverse transfer module which is a module that remaps the feature vector of the first task mapped to the second latent space to the first latent space.

In another aspect, the task processing unit further includes a head module which is a module that generates a prediction value according to the feature vector of the first task.

In another aspect, the integrated latent space is a virtual space that matches geometric properties of feature vectors between the plurality of tasks.

In another aspect, the simultaneous training of the plurality of tasks based on the plurality of task processing units includes mapping the feature vector of each of the plurality of tasks to the latent space corresponding to each of the plurality of tasks, and geometrically aligning the plurality of feature vectors mapped to the latent space through the integrated latent space.

In another aspect, the geometrically aligning includes acquiring a geometric alignment vector, which is a vector supporting geometric alignment in the integrated latent space, based on the experimental data, calculating a geometric alignment loss based on the acquired geometric alignment vector, and updating a parameter of the multi-tasking model based on the calculated geometric alignment loss.

In another aspect, the simultaneous training of the plurality of tasks based on the plurality of task processing units further includes simultaneously performing the geometric alignment for n*n (n>=2) combinations of physical properties when simultaneously training the plurality of tasks based on n (n>=2) physical properties.

In another aspect, the simultaneous performing of the geometric alignment includes simultaneously performing the geometric alignment by applying the same transformation method to each of the n*n (n>=2) physical property combinations.

In another aspect, the acquiring of the experimental data includes acquiring physical property relationship information, which is information specifying a relationship between the plurality of physical properties, based on prompt engineering based on a predetermined pre-trained language model.

In another aspect, the physical property relationship information includes information specifying physical properties related to a predetermined physical property, information specifying an attribute of a relationship between the related physical properties, and information specifying an association degree according to the attribute of the relationship.

In another aspect, the calculating of the geometric alignment loss includes adjusting weight of the geometric alignment loss based on the physical property relationship information.

Meanwhile, there is provided a system for performing pre-training for a multi-tasking model according to an embodiment of the present disclosure, the system including: at least one memory; and at least one processor for performing the pre-training of the multi-tasking model by reading out at least one application stored in the memory, in which an instruction of the processor includes an instruction of acquiring experimental data including material-specific characteristic information, which is information specifying unique characteristics of a predetermined material, and material-physical property specific information, which is information specifying characteristic values that the material has for a plurality of physical properties, an instruction of simultaneously training a multi-tasking model to perform a plurality of tasks for predicting the characteristic value for each of the plurality of physical properties based on the acquired experimental data, and an instruction of providing the trained multi-tasking model, and the instruction of the processor further includes an instruction of simultaneously training the plurality of tasks based on a plurality of task processing units including a first task processing unit, which is a module for processing a plurality of sub-tasks for predicting a characteristic value for a first physical property, a second task processing unit, which is a module for processing a plurality of sub-tasks for predicting a characteristic value for a second physical property, and an nth task processing unit, which is a module for processing a plurality of sub-tasks for predicting a characteristic value for an nth (n>=2) physical property.

A pre-training method and system for a multi-tasking model according to one embodiment of the present disclosure may perform transfer learning through geometric alignment in an integrated latent space for multiple tasks according to the plurality of domains, thereby accurately predicting an integrated output that satisfies each requirement according to the plurality of domains.

In addition, a pre-training method and system for a multi-tasking model according to one embodiment of the present disclosure may simultaneously train various prediction tasks according to the plurality of domains in the transfer learning process, thereby training not only individual principles of each domain but also correlations between domains and common principles for the entire domain, and expanding a model learning area and expanding the prediction acceptance range for each domain and domain at the same time.

Therefore, a pre-training method and system for a multi-tasking model according to one embodiment of the present disclosure may improve the performance and quality of processing various multi-tasking tasks using the trained model.

In addition, a pre-training method and system for a multi-tasking model according to one embodiment of the present disclosure may easily support the transfer of knowledge between interrelated data and the improvement of prediction performance accordingly by implementing the exchange of mutual information by matching geometric properties between the various prediction tasks.

In addition, a pre-training method and system for a multi-tasking model according to one embodiment of the present disclosure may increase resistance to unnecessary interference information and increase the stability of the model.

In addition, a pre-training method and system for a multi-tasking model according to one embodiment of the present disclosure may increase the diversity of data used for model learning and improve learning performance by allowing the model to train more information by securing a data set for training using source data from various sources.

In addition, a pre-training method and system for a multi-tasking model thereof according to one embodiment of the present disclosure may predict the plurality of physical properties for a specific material by applying the multi-tasking learning model trained as above to predict relationships between the plurality of physical properties and materials, and provide a multi-tasking model capable of predicting a specific material satisfying the plurality of physical properties, thereby providing a multi-tasking model that can be universally utilized for various materials (subject matters) and having the effect of improving the quality of the entire related industry.

A pre-training method and system for a multi-tasking model according to one embodiment of the present disclosure may provide a multi-tasking model that maintains high performance for multiple tasks even on a small data set by solving the problem of insufficient data by transferring knowledge trained from a source task to a target task through transfer learning.

Therefore, a pre-training method and system for a multi-tasking model according to one embodiment of the present disclosure may effectively expand the scope of application to fields where it is difficult to apply machine learning models due to insufficient data or domain knowledge.

In addition, a pre-training method and system for a multi-tasking model according to one embodiment of the present disclosure may provide a specialized transfer learning technique that can be effectively applied to regression problems, thereby demonstrating high prediction performance even in complex regression problems such as molecular data sets.

In addition, a pre-training method and system for a multi-tasking model according to one embodiment of the present disclosure may improve the efficiency of transfer learning by maintaining geometric consistency between tasks by optimizing knowledge transfer between source tasks and target tasks through a Riemannian geometric approach.

In addition, a pre-training method and system for a multi-tasking model according to one embodiment of the present disclosure may further improve the generalization performance of a model by combining the plurality of loss functions to regularize various aspects of the model.

However, effects obtainable from the present disclosure is not limited to the effects mentioned above, and other effects not mentioned above may be clearly understood from the description below.

### BRIEF DESCRIPTION OF THE DRAWING

FIG. 1 illustrates a block diagram of a computing system implementing a multi-tasking model pre-training service according to one embodiment of the present disclosure.

FIG. 2 illustrates a block diagram of a computing device implementing a multi-tasking model pre-training service according to one embodiment of the present disclosure.

FIG. 3 illustrates a block diagram of another aspect of a computing device implementing a multi-tasking model pre-training service according to one embodiment of the present disclosure.

FIGS. 4 and 5 illustrate conceptual diagrams for explaining a multi-tasking learning model according to one embodiment of the present disclosure.

FIG. 6 illustrates a conceptual diagram of a multi-tasking learning model for predicting the plurality of physical property values for a specific material according to one embodiment of the present disclosure.

FIG. 7 illustrates an internal block diagram of the multi-tasking learning model according to one embodiment of the present disclosure.

FIG. 8 illustrates a conceptual diagram for explaining a multi-tasking learning model including a plurality of task processing units according to one embodiment of the present disclosure.

FIG. 9 illustrates a conceptual diagram for explaining a multi-tasking model training method according to one embodiment of the present disclosure.

FIG. 10 illustrates a flowchart diagram for explaining a multi-tasking model training method according to one embodiment of the present disclosure.

FIG. 11 illustrates a knowledge graph representing a relationship between physical properties according to one embodiment of the present disclosure.

FIG. 12 illustrates a flowchart diagram for explaining a multi-tasking learning model training method according to one embodiment of the present disclosure.

FIG. 13 illustrates a first conceptual diagram for explaining a multi-tasking learning model training method according to one embodiment of the present disclosure.

FIG. 14 illustrates a second conceptual diagram for explaining a multi-tasking learning model training method according to one embodiment of the present disclosure.

FIGS. 15 and 16 illustrate diagrams for explaining a regression loss calculation method according to one embodiment of the present disclosure.

FIG. 17 illustrates a diagram for explaining an integrated latent space mapping method according to one embodiment of the present disclosure.

FIGS. 18 and 19 illustrate diagrams for explaining a consistency loss calculation method according to one embodiment of the present disclosure.

FIGS. 20 and 21 illustrate diagrams for explaining a mapping loss calculation method according to one embodiment of the present disclosure.

FIG. 22 illustrates a diagram for explaining an integrated loss calculation method according to one embodiment of the present disclosure.

FIG. 23 illustrates a flowchart diagram for explaining a guide providing method for supporting performance improvement of a multi-tasking model according to one embodiment of the present disclosure.

FIG. 24 illustrates a diagram for explaining a validity index according to one embodiment of the present disclosure.

FIG. 25 illustrates a diagram for explaining the background of the use of a density estimation algorithm according to one embodiment of the present disclosure.

FIG. 26 illustrates examples of output data based on a density estimation algorithm according to one embodiment of the present disclosure.

FIG. 27 illustrates an example of visualizing a physical property guide according to one embodiment of the present disclosure.

FIG. 28 illustrates an example for explaining a physical property change interface according to one embodiment of the present disclosure.

### DETAILED DESCRIPTION

The present disclosure may be modified in various ways and has various embodiments, and thus specific embodiments are illustrated in the drawings and described in detail in the detailed description. The effects and features of the present disclosure and the methods for achieving them will become clear with reference to the embodiments described in detail below together with the drawings. However, the present disclosure is not limited to the embodiments disclosed below, but can be implemented in various forms. In the following embodiments, the terms “first”, “second”, or the like are not used in a limiting sense, but are used for the purpose of distinguishing one component from another component. In addition, the singular expression includes the plural expression unless the context clearly indicates otherwise. In addition, the terms “include” or “have” mean that the features or components described in the specification are present, and do not preemptively exclude the possibility that one or more other features or components may be added. In addition, the sizes of the components in the drawings may be exaggerated or reduced for the convenience of explanation. For example, the sizes and thicknesses of each component illustrated in the drawings are arbitrarily illustrated for the convenience of explanation, and therefore the present disclosure is not necessarily limited to what is illustrated.

Hereinafter, embodiments of the present disclosure will be described in detail with reference to the attached drawings. When describing with reference to the drawings, identical or corresponding components are assigned the same drawing reference numerals, and redundant descriptions thereof are omitted.

### [System Implementing Multi-Tasking Model Pre-Training Service]

Hereinafter, a system providing a multi-tasking model pre-training service that performs transfer learning through geometric alignment in an integrated latent space for multiple tasks according to a plurality of domains according to an exemplary embodiment of the present disclosure is described in detail with reference to the attached drawings.

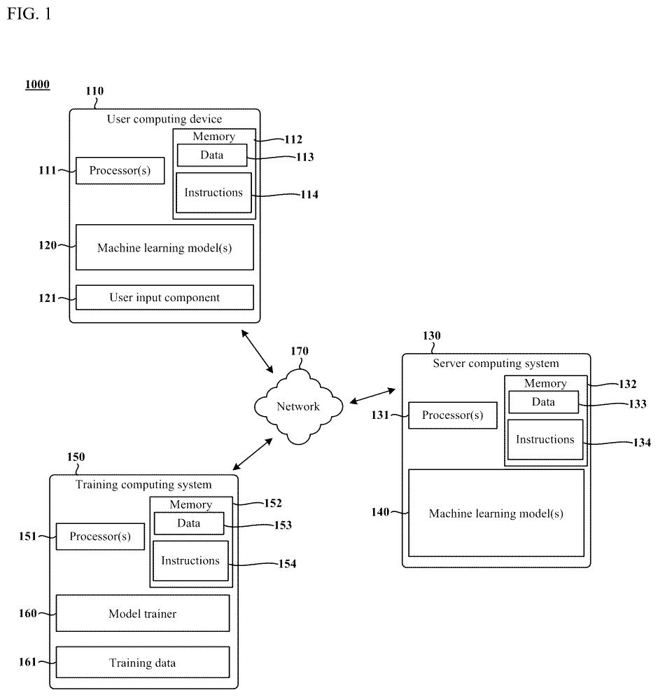

FIG. 1 illustrates a block diagram of a computing system implementing a multi-tasking model pre-training service according to one embodiment of the present disclosure.

Referring to FIG. 1, a computing system 1000 implementing a multi-tasking model pre-training service according to an embodiment of the present disclosure includes a user computing device or a user computer 110, a server computing system or a server 130, and a training computing system or a training computer 150. One or more of these devices may be capable of communicating via a network 170.

A pre-training method and system for a multi-tasking model according to one embodiment of the present disclosure may 1) be implemented and provided locally by a user computing device or a user computer 110, 2) be implemented and provided in the form of a web service by a server computing system or a server 130 communicating with the user computing device 110, or 3) be implemented and provided by both the user computing device 110 and the server computing system 130 in connection with each other.

In an embodiment, the user computing device 110 and/or the server computing system 130 may train the machine learning model 120 and/or 140 through interaction with the training computing system 150 communicatively connected via the network 170. The training computing system 150 may be a system separate from the server computing system 130, or may be a part of the server computing system 130.

Moreover, the artificial intelligence model may 1) be trained directly locally by the user computing device 110, 2) be trained by the server computing system 130 and the user computing device 110 interacting with each other through the network 170, and 3) be trained by another separate training computing system 150 using various training techniques and learning techniques. Moreover, the artificial intelligence model trained by the training computing system 150 may be implemented in a manner of being provided/updated by transmitting the artificial intelligence model to the user computing device 110 and/or the server computing system 130 through the network 170.

In some embodiments, the training computing system 150 may be a part of the server computing system 130 or a part of the user computing device 110.

The user computing device 110 may include any type of computing devices or computers, such as a smart phone, a mobile phone, a digital broadcasting device, a personal digital assistant (PDA), a portable multimedia player (PMP), a desktop, a wearable device, an embedded computing device, and/or a tablet personal computer (PC).

The user computing device 110 includes at least one processor 111 and memory 112. Here, the processor 111 may include one or more among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions. The processor 111 may include one single processor or a plurality of processors electrically connected.

The memory 112 may include one or more non-transitory and/or transitory computer-readable storage media, such as RAM, ROM, EEPROM, EPROM, flash memory devices, magnetic disks, and combinations thereof, and may include web storage of a server that performs a storage function of memory on the Internet. The memory 112 may store data 113 and commands 114 which may be executed by the processor 111 to perform functional operations, such as training an artificial intelligence model or executing multi-tasking training through an artificial intelligence model.

In one embodiment, the user computing device 110 may store at least one machine learning model 120.

In detail, the machine learning model 120 may be various machine learning models such as the plurality of neural networks (for example, deep neural networks) or other types of machine learning models including non-linear models and/or linear models, and may be a combination thereof.

For example, the neural network may include one or more of feed-forward neural networks, recurrent neural networks (for example, long short-term memory recurrent neural networks), convolutional neural networks, and/or other forms of neural networks.

In one embodiment, the user computing device 110 may receive at least one machine learning model 120 from the server computing system 130 via the network 170, store the machine learning model 120 in the memory 112, and execute the stored machine learning model 120 by the processor 111 to perform multi-tasking training, or the like.

In another embodiment, the server computing system 130 may perform operations via the machine learning model 140, including at least one machine learning model 140, and may provide the multi-tasking model pre-training service to the user by communicating data related thereto with the user computing device 110 in linkage with the user computing device 110.

For example, the user computing device 110 may perform the multi-tasking model pre-training service in a manner that the server computing system 130 provides output for a user's input using the machine learning model 140 via the web.

Additionally, the artificial intelligence model may be implemented in such a way that at least one of the machine learning models 120 and/or 140 are executed on the user computing device 110 and the other of the machine learning models 120 and/or 140 is executed on the server computing system 130.

In addition, the user computing device 110 may include at least one input component 121 that detects or receives the user's input. For example, the user input component 121 may include a touch sensor (for example, a touch screen and/or a touch pad, or the like) that detects a touch of a user's input medium (for example, a finger or a stylus), an image sensor that detects a user's motion input, a microphone that detects a user's voice input, a button, a mouse, and/or a keyboard, or the like. In addition, the user input component 121 may include an interface and an external controller when an external controller (for example, a mouse and/or a keyboard, or the like) receives an input through the interface.

The server computing system 130 includes at least one processor 131 and memory 132. Here, the processor 131 may include at least one among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions. For example, the processor 131 may include one single processor or a plurality of processors electrically connected.

Moreover, the memory 132 may include one or more non-transitory and/or transitory computer-readable storage media, such as RAM, ROM, EEPROM, EPROM, flash memory devices, magnetic disks, or the like, and combinations thereof. The memory 132 may store data 133 and instructions 134 which may be executed by the processor 131 to perform functional operations, such as training an artificial intelligence model or executing multi-tasking training through an artificial intelligence model.

In one embodiment, the server computing system 130 may be implemented to include at least one computing device. For example, the server computing system 130 may be configured to operate the plurality of computing devices according to a sequential computing architecture, a parallel computing architecture, or a combination thereof. Additionally, the server computing system 130 may include a plurality of computing devices connected to the network 170.

Additionally, the server computing system 130 may store at least one machine learning model 140. For example, the server computing system 130 may include a neural network and/or other multi-layer non-linear model as the machine learning model 140. Exemplary neural networks may include feed-forward neural networks, deep neural networks, recurrent neural networks, and convolutional neural networks.

The training computing system 150 includes at least one processor 151 and a memory 152. Here, the processor 151 may include at least one among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions. The processor 151 may include one single processor or a plurality of processors electrically connected.

Moreover, the memory 152 may include one or more non-transitory and/or transitory computer-readable storage media, such as RAM, ROM, EEPROM, EPROM, flash memory devices, magnetic disks, or the like, and combinations thereof. The memory 152 may store data 153 and instructions 154 that may be executed by the processor 151 to perform training of an artificial intelligence model, or the like.

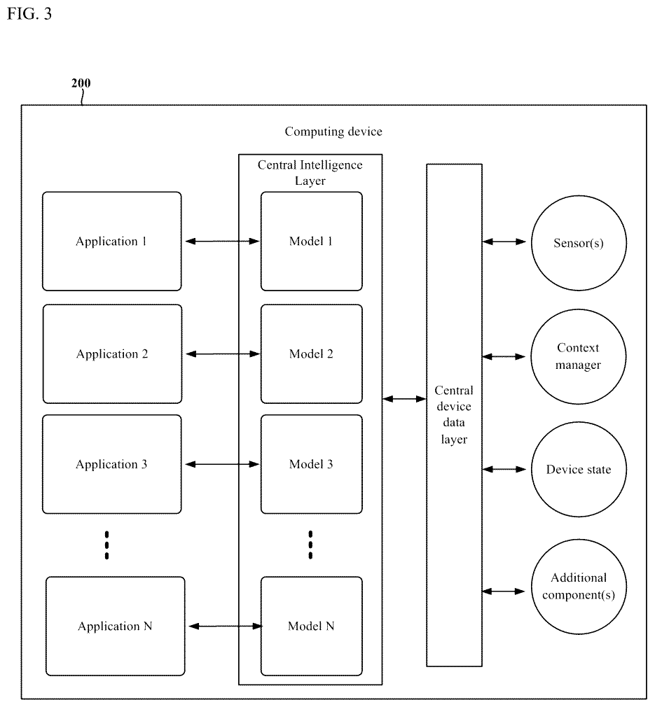

For example, the training computing system 150 may include a model trainer 160 that trains the machine learning model 120 and/or 140 stored on the user computing device 110 and/or server computing system 130 using various training or learning techniques, such as backpropagation of errors according to a framework illustrated in FIG. 3.

For example, the model trainer 160 may perform updates to one or more parameters of the machine learning model 120 and/or 140 in a backpropagation manner based on a defined loss function.

In some implementations, performance of backward propagation of the error may include performance of truncated backpropagation through time. The model trainer 160 may perform a number of generalization techniques (for example, weight reduction, dropout, and/or knowledge distillation) to improve the generalization ability of the machine learning model 120 and/or 140 being trained.

In particular, the model trainer 160 may train the machine learning model 120 and/or 140 based on a series of training data 161. Here, the training data 161 may include data in different forms, such as, images, audio samples, and/or text. Examples of image types that can be used include video frames, LiDAR point clouds, X-ray images, computed tomography scans, hyperspectral images, and/or various other forms of images.

The training data 161 may be provided by the user computing device 110 and/or the server computing system 130. For instance, when the training computing device trains the machine learning model 120 and/or 140 for specific data of the user computing device 110, the machine learning model 120 and/or 140 may be characterized as a personalized model.

Moreover, the model trainer 160 includes computer logic utilized to provide the desired functionality.

Additionally, the model trainer 160 may be implemented as hardware, firmware, and/or software that controls a general-purpose processor. In one exemplary implementation, the model trainer 160 includes a program file stored in a storage device and the program file may be loaded into the memory 152 and executed by one or more processors 151. In another exemplary implementation, the model trainer 160 includes one or more sets of computer-executable data 153 and instructions 154 stored in a computer-readable storage medium, such as a RAM hard disk or an optical or magnetic medium.

The network 170 includes, for example, but not limited to, a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (Wireless LAN), a Wide Area Network (WAN), a Personal Area Network (PAN), a Bluetooth network, a satellite broadcasting network, an analog broadcasting network, and/or a Digital Multimedia Broadcasting (DMB) network.

In general, communication over the network 170 may be performed using any type of wired and/or wireless connection, through various communication protocols (for example, TCP/IP, HTTP, SMTP, and/or FTP, or the like), encodings or formats (for example, HTML and/or XML, or the like), and/or protection schemes (for example, VPN, Secure HTTP, ad/or SSL, or the like).

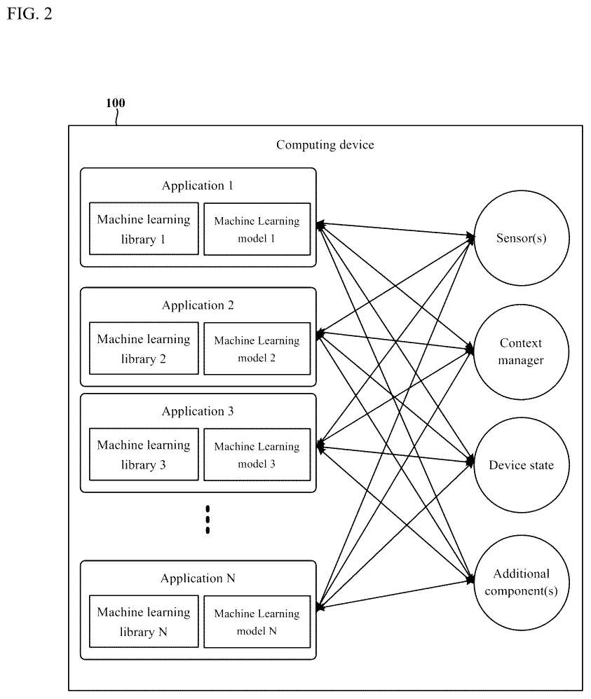

FIG. 2 illustrates a block diagram of a computing device implementing a multi-tasking model pre-training service according to one embodiment of the present disclosure.

As illustrated in FIG. 2, the computing device 100 included in one or more of the user computing device 110, the server computing system 130, and the training computing system 150 includes a plurality of applications (for example, application 1 to application N). Each application may include a machine learning library and one or more machine learning models. For example, the application may include an application for image processing (for example, Detection, Classification, and/or Segmentation, or the like), a text messaging application, an email application, a dictation application, a virtual keyboard application, a browser application, and/or a Chat-bot application.

In an embodiment, the computing device 100 may include the model trainer 160 for training an artificial intelligence model, and may store and operate the trained artificial intelligence model to provide output data according to predetermined input data (for example, material-specific characteristic information and/or material-physical property specific information, or the like).

Each application of the computing device 100 may communicate with another or other components of the computing device 100, such as, for example, one or more sensors, a context manager, a device state component, and/or additional components. In one embodiment, each application may communicate with each device component using an API (for example, a public API). In one embodiment, the API used by each application may be specific to that application.

FIG. 3 illustrates a block diagram of another aspect of a computing device implementing a multi-tasking model pre-training service according to one embodiment of the present disclosure.

Referring to FIG. 3, a computing device 200 includes a number of applications (for example, Application 1 through Application N). Each application may communicate with a central intelligence layer. For example, the application may include an image processing application, a text messaging application, an email application, a dictation application, a virtual keyboard application, and/or a browser application. In one embodiment, each application may communicate with the central intelligence layer (and models stored therein) using an API (for example, a common API across all applications).

The central intelligence layer may include the plurality of machine learning models. For example, as illustrated in FIG. 3, at least some of the machine learning models may be provided for each application and managed by the central intelligence layer. In other implementations, two or more applications may share a single machine learning model. For example, in some implementations, the central intelligence layer may provide a single model for all applications. In some implementations, the central intelligence layer may be included within the operating system of the computing device 200 or implemented otherwise.

The central intelligence layer may communicate with a central device data layer. The central device data layer may be centralized data storage for the computing device 200. As illustrated in FIG. 3, the central device data layer can communicate with another or other components of the computing device 200, such as, one or more sensors, a context manager, a device state component, and/or additional components. In some implementations, the central device data layer may communicate with each device component using an API (for example, a private API).

The embodiments or techniques described herein may reference servers, databases, software applications, and other computer-based systems, as well as actions taken and information transmitted to or from such systems. The inherent flexibility of computer-based systems allows for a wide range of possible configurations, combinations, and division of work and functionality between and among components. For example, the processes described herein may be implemented using a single device or component, or the plurality of devices or components operating in combination. Databases and applications may be implemented on a single system or in a distributed system across the plurality of systems. Distributed components may operate sequentially or in parallel.

### [Multi-Tasking Learning Model (MtLM)]

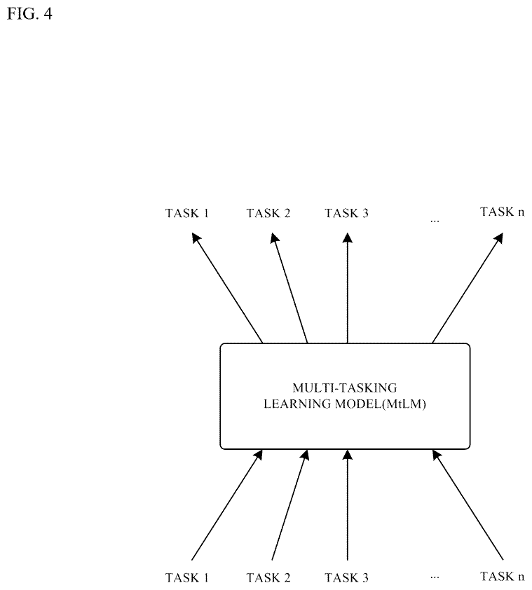

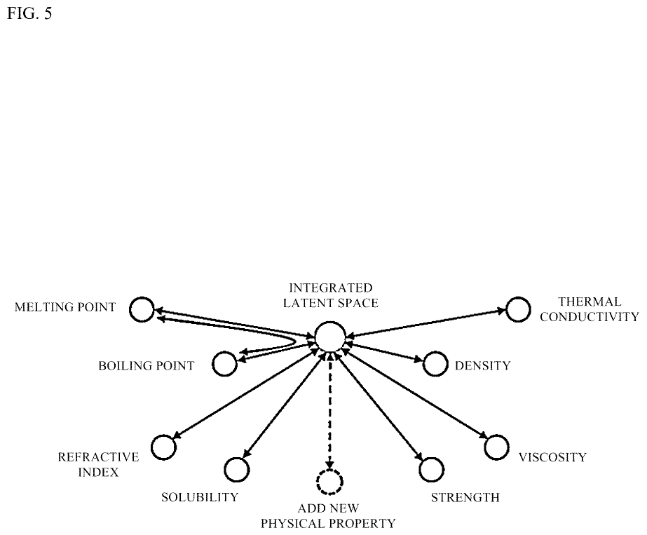

FIGS. 4 and 5 illustrate conceptual diagrams for explaining a multi-tasking learning model (MtLM) according to one embodiment of the present disclosure.

Referring to FIGS. 4 and 5, the multi-tasking learning model (MtLM) (e.g. Geometrically Aligned Transfer Encoder Model) according to an embodiment of the present disclosure may be a machine learning model that aligns fragmented knowledge data (for example, latent vectors, or the like) in each task's latent space through geometric transfer in a single integrated latent space (M: Manifold) in order to process multiple tasks for an integrated output satisfying the plurality of domains.

Here, the latent space according to an embodiment may mean a high-dimensional space in which a predetermined data is located after being transformed through an encoding process. In the latent space, important characteristics of the data may be expressed in a compressed form.

The integrated latent space (M) according to an embodiment may be a virtual space that geometrically expresses predetermined data, and the transformation between the single latent space and the integrated latent space (M) may serve to match the geometric properties of the data.

Building on the above, the multi-tasking learning model (MtLM) according to an embodiment may perform effective multi-task learning that simultaneously trains knowledge data according to various domains and efficiently trains relationships between the plurality of domains, thereby expanding the learning area and simultaneously implementing batch learning of local patterns according to each domain and common principles between the plurality of domains.

Accordingly, the multi-tasking learning model (MtLM) can directly improve the processing performance and accuracy of various multi-tasking tasks based on the trained model as described above.

In the following examples, the multi-tasking learning model (MtLM) will be described as an example of a relationship between a predetermined material and the plurality of physical properties, and will be described as a learning model that multitasks multiple tasks, including a first task of predicting a characteristic of a first physical property for a material, a second task of predicting a characteristic of a second physical property for the material, and so on. However, it should be understood that the present disclosure is not limited to a training method and a prediction method for multi-tasking the relationships between the material and the plurality of physical properties, and may be applied to all kinds of tasks that require performing a plurality of tasks simultaneously, such as the relationships between the material and the plurality of physical properties.

Therefore, the domain according to the following examples may mean a category (field) that predicts a predetermined physical property (for example, a boiling point, melting point, refractive index, solubility, viscosity, surface tension, density, strength, and/or thermal conductivity, or the like).

In an embodiment, the multi-tasking learning model (MtLM) may perform pre-training based on predetermined experimental data.

Here, the experimental data according to an embodiment may refer to training data used for training the multi-tasking learning model (MtLM), and may include predetermined input data and corresponding output data (e.g., label) information.

In an embodiment, the experimental data may be data including predetermined material-specific characteristic information and corresponding material-specific characteristic information. That is, in an embodiment, the experimental data may be data including predetermined material-specific characteristic information as input data and material-physical property specific information as output data (i.e., a label) mapped to the input material-specific characteristic information.

In this case, the material-specific characteristic information according to an embodiment may be information that specifies unique characteristics possessed by a predetermined material.

For example, the material-specific characteristic information may include at least one of data such as a predetermined material name, molecular structural formula, and/or chemical formula data. In the following description, the material-specific characteristic information is limited to molecular structural formula (for example, n-dimensional molecular structural formula (n≥2)) data.

In addition, the material-physical property specific information according to an embodiment may be information that specifies a data value (e.g., a characteristic value of the physical property, where the value includes a range) that a predetermined material has for a predetermined physical property.

For example, the material-physical property specific information may include physical property (e.g., domain) values of a predetermined material, such as a boiling point, melting point, refractive index, solubility, viscosity, surface tension, density, strength, and/or thermal conductivity.

In the following examples, the molecular structural formula data representing the material-specific characteristic information is used as input data, and physical property value data for each task is used as output data.

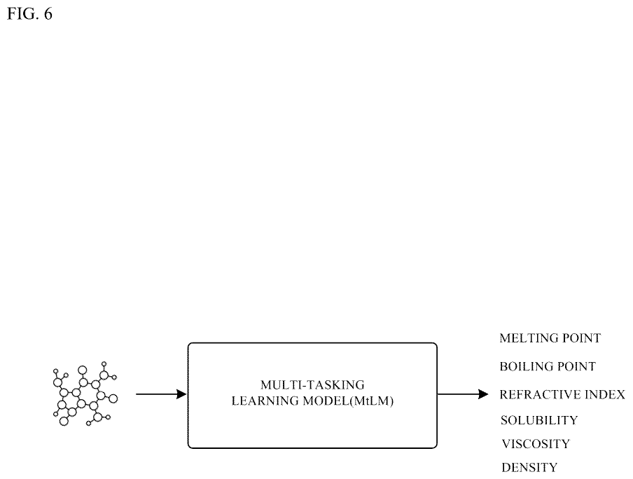

FIG. 6 illustrates a conceptual diagram of a multi-tasking learning model for predicting the plurality of property values for a specific material according to one embodiment of the present disclosure.

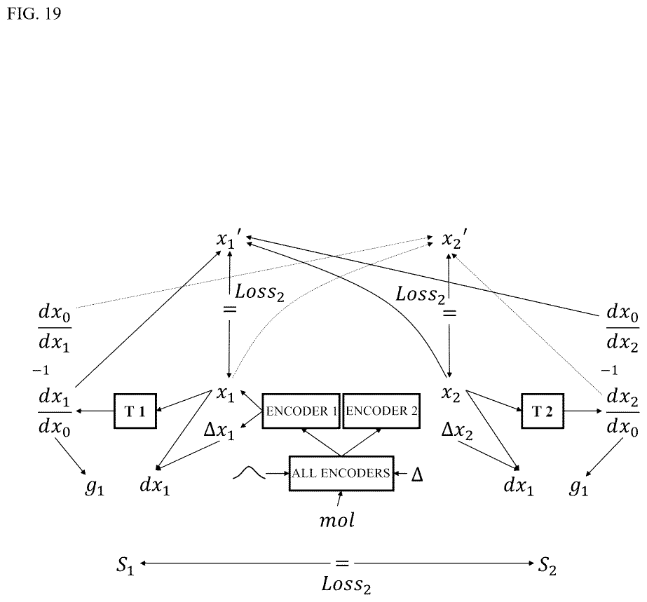

Accordingly, referring to FIG. 19, the multi-tasking learning model (MtLM) according to an embodiment of the present disclosure may be a multi-tasking model that performs multiple tasks to predict outputs for the plurality of domains (for example, the plurality of physical properties such as a boiling point, melting point, refractive index, solubility, viscosity, surface tension, density, strength, and/or thermal conductivity) based on predetermined input data (for example, predetermined molecular structural formula data, or the like).

Accordingly, the task described above may be to predict the plurality of domain-specific outputs (that is, the plurality of physical property values) for input data (for example, predetermined molecular structural formula data, or the like).

In an embodiment, the tasks may include a first task for predicting a first physical property value for a predetermined material, a second task for predicting a second physical property value for the material, . . . and an n-th task for predicting an n-th (n≥2) physical property value for the material, and each of the tasks described above may include a plurality of sub-tasks for predicting physical property values mapped to each task.

In an embodiment, the task may include the plurality of sub-tasks for predicting physical property values mapped to the n-th task, and a main task including the plurality of sub-tasks. In this case, the main task may correspond to the mapped n-th task.

In addition, a task according to an embodiment may include a source task, which is a side task that provides data to be transferred in a transfer learning process according to an embodiment of the present disclosure, and a target task, which is a side task that receives data to be transferred.

In other words, in an embodiment, a task may be defined as a source task or a target task depending on whether the task corresponds to the subject that transfers the data in the training process or the subject that receives the data.

To summarize, the multi-tasking learning model (MtLM) that has performed pre-training according to an embodiment of the present disclosure may receive the predetermined material-specific characteristic information and/or material-physical property specific information as input, and output predicted data based on the input information and trained knowledge.

As an example, the multi-tasking learning model (MtLM) may receive the predetermined material-specific characteristic information as input and output the predicted material-physical property specific information based on the input information and trained knowledge.

In this case, according to an embodiment, the multi-tasking learning model (MtLM) may receive predetermined material-physical property specific information as input and output the predicted material-specific characteristic information based on the input information and trained knowledge.

That is, the multi-tasking learning model (MtLM) may include a model that is reverse-engineered to predict and output the material-specific characteristic information according to the predetermined material-physical property specific information.

In addition, according to an embodiment, the multi-tasking learning model (MtLM) may receive the predetermined material-specific characteristic information and material-physical property specific information as input, and output the optimal material-specific characteristic information and material-physical property specific information predicted based on the input information and trained knowledge.

That is, the multi-tasking learning model (MtLM) may include a model reverse-engineered to output the optimal material-specific characteristic information and material-physical property specific information predicted based on the predetermined material-specific characteristic information and material-physical property specific information.

As described above, the multi-tasking learning model (MtLM) according to an embodiment of the present disclosure trains not only the principles between materials and individual physical properties but also the relationships between physical properties and common principles for all trained physical properties in the process of simultaneously training tasks for predicting the plurality of physical properties for a predetermined material, thereby enabling more accurate prediction of physical property values and making updates easier.

In addition, the multi-tasking learning model (MtLM) according to an embodiment of the present disclosure has the advantage of being able to perform learning on a wider range of materials since the training data for the plurality of physical properties are related to various materials, thereby further expanding the predictable range of materials for each physical property.

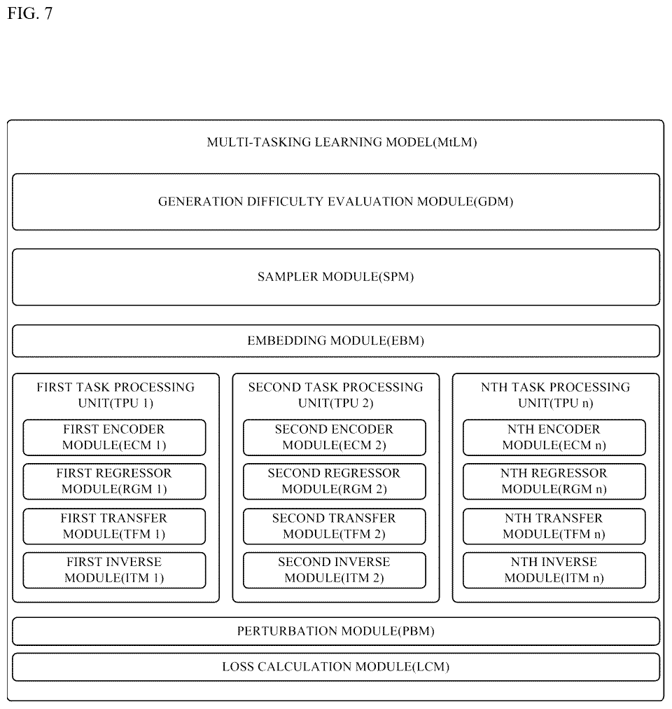

FIG. 7 illustrates an internal block diagram of the multi-tasking learning model (MtLM) according to one embodiment of the present disclosure.

Referring to FIG. 7, in another aspect, the multi-tasking learning model (MtLM) according to an embodiment may include at least one embedding module (EBM), a task processing unit (TPU), an encoder module (ECM), a regressor module (RGM), a transfer module (TFM), an inverse transfer module (ITM), a perturbation module (PBM), and a loss calculation module (LCM).

In detail, the embedding module (EBM) according to an embodiment of the present disclosure may be a pre-encoder module that transforms predetermined input data into an embedding vector.

Specifically, the embedding module (EBM) compresses high-dimensional data, such as molecular structure data, into a low-dimensional representation, such as an embedding vector, thereby reducing the dimension of the input to be processed by the encoder, thereby improving computational efficiency and learning speed, and allowing the encoder to focus on and train important features in the molecular structural formula for the pre-training task.

Through this, useful features from the trained model of the source task can be easily applied to the model that trains the target task, and generalization may be accomplished for overlapping features between different domains, so transfer learning for new domains and/or tasks can be effectively performed.

In other words, the embedding module (EBM) can be a module that transforms specific input data into a vector format by projecting the input data into a predetermined embedding space.

As an example, as the embedding module (EBM), a graph neural network (GNN) suitable for extracting the molecular structural features may be used, and for example, an embedding vector for input data may be provided based on a directed message passing neural network (DMPNN) structure.

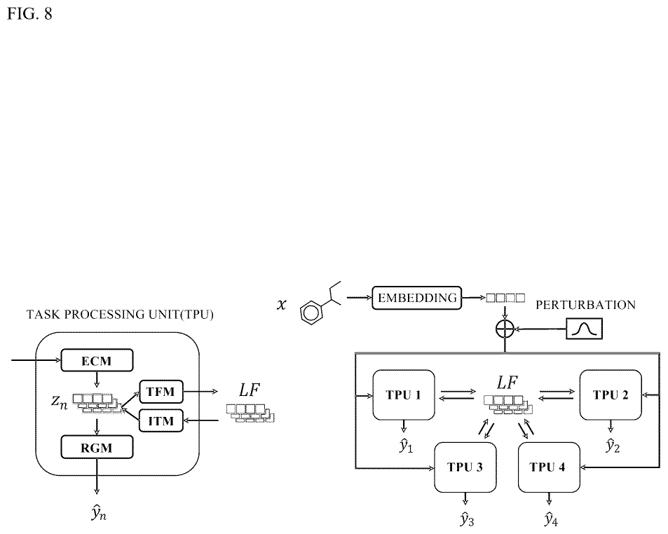

FIG. 8 illustrates a conceptual diagram for explaining a multi-tasking learning model (MtLM) including a plurality of task processing units (TPUs) according to one embodiment of the present disclosure.

In addition, referring to FIG. 8, the task processing unit (TPU) according to an embodiment of the present disclosure may be a module that performs a learning and prediction process based on a predetermined task.

In an embodiment, the task processing unit (TPU) may include a first task processing unit corresponding to a first domain (for example, a boiling point), a second task processing unit corresponding to a second domain (for example, a melting point), . . . , and an n-th task processing unit corresponding to an n-th domain.

That is, in an embodiment, the task processing unit (TPU) may include a plurality of first to n-th task processing units (TPUs) corresponding to the number of given domains (that is, physical properties).

In this case, in an embodiment, any one of the plurality of task processing units (TPUs) may be a source task processing unit (TPU) which is a task processing unit (TPU) corresponding to the source task of transfer learning according to an embodiment of the present disclosure.

In addition, among the remaining task processing units (TPUs) excluding the source task processing unit, any one of the task processing units (TPUs) may be a target task processing unit (TPU) which is a task processing unit (TPU) corresponding to the target task of transfer learning according to an embodiment of the present disclosure.

In detail, the task processing unit (TPU) according to an embodiment may include at least one encoder module (ECM), a regressor module (RGM), a transfer module (TFM), and an inverse transfer module (ITM).

Specifically, the encoder module (ECM) according to an embodiment of the present disclosure may be a module that receives a predetermined embedding vector as input and transforms the input embedding vector into a latent vector by projecting the input embedding vector into a latent space corresponding to a corresponding task.

In other words, the encoder module (ECM) may be a module that extracts key features of the input embedding vector and expresses the key features on the corresponding latent space. In detail, the encoder module (ECM) may extract important features from among the features of the embedding vector, perform data compression such as removing unnecessary information or noise while compressing the data into a low-dimensional space, and output the data as the latent vector, which is an expression in the latent space.

In an embodiment, the encoder module (ECM) may include a plurality of encoder modules (ECMs) corresponding to each of the plurality of domains.

In an embodiment, the encoder module (ECM) may include a first encoder module corresponding to a first domain (for example, a boiling point), a second encoder module corresponding to a second domain (for example, a melting point), . . . , and an n-th encoder module corresponding to an nth domain.

In another embodiment, the encoder module (ECM) may include a third encoder module for performing a first task of predicting solubility for a first solvent corresponding to a third domain (for example, solubility), and a fourth encoder module for performing a second task of predicting solubility for a second solvent. That is, in another embodiment, it may include a case of multitasking for different tasks for the same domain. Of course, a multi-tasking model that integrates multitasking for different domains and multitasking for different tasks in the same domain may also be included in one embodiment of the present disclosure.

In the following, it will be explained based on the assumption that different domains represent different tasks.

In this case, in an embodiment, one of the plurality of encoder modules (ECMs) may be a source encoder module, which is an encoder module (ECM) corresponding to the source task of the transfer learning according to an embodiment of the present disclosure.

In addition, among the remaining encoder modules (ECMs) excluding the source encoder module, any one of the encoder modules (ECMs) may be a target encoder module (ECM), which is an encoder module (ECM) corresponding to a target task of the transfer learning according to an embodiment of the present disclosure.

In addition, the regressor module (RGM) according to an embodiment of the present disclosure may be a head module that takes a predetermined latent vector as input and generates a final prediction value according to the input latent vector. That is, in an embodiment, the regressor module (RGM) is used as an example of the head module.

The regression module (RGM) may directly participate in generating the final output and thus determine the model's predictive performance.

Additionally, in an embodiment, the regressor module (RGM) may include the plurality of regressor modules (RGMs) corresponding to the plurality of domains, respectively.

In an embodiment, the regressor module (RGM) may include a first regressor module corresponding to a first domain (for example, a boiling point), a second regressor module corresponding to a second domain (for example, melting point), . . . , and an n-th regressor module corresponding to an n-th domain.

In this case, among the plurality of regressor modules (RGMs) in an embodiment, one regressor module (RGM) may be a source regressor module (RGM), which is a regressor module (RGM) corresponding to the source task of the transfer learning according to an embodiment of the present disclosure.

In addition, among the remaining regressor modules (RGMs) excluding the source regressor module, any one of the regressor modules (RGMs) may be a target regressor module (RGM), which is a regressor module (RGM) corresponding to the target task of the transfer learning according to an embodiment of the present disclosure.

In addition, the transfer module (TFM) according to an embodiment of the present disclosure may be a module that transforms a predetermined latent vector into a transfer vector by mapping the predetermined latent vector to a latent space of another task.

In detail, in an embodiment, the transfer module (TFM) can transform a specific latent vector into the transfer vector by mapping the specific latent vector to the latent space of another task through the integrated latent space (M) based on Riemannian geometry.

In this process, the transfer module (TFM) can implement geometric alignment between the mapped tasks according to an embodiment of the present disclosure. A detailed description of this will be described later in the multi-tasking model training method.

That is, in an embodiment, the transfer module (TFM) can effectively perform the transfer of knowledge data between the plurality of tasks by mapping the latent vector according to the first task to the latent space according to the second task through the geometric alignment according to an embodiment of the present disclosure.

In this case, the transfer module (TFM) in an embodiment may support data processing that improves the accuracy and consistency of the transformed vector (that is, a transfer vector) by utilizing an autoencoder structure.

Additionally, in an embodiment, the transfer module (TFM) may include the plurality of transfer modules (TFMs) corresponding to the plurality of domains, respectively.

In an embodiment, the transfer module (TFM) may include a first transfer module corresponding to a first domain (for example, a boiling point), a second transfer module corresponding to a second domain (for example, a melting point), . . . , and an nth transfer module corresponding to an n-th domain.

In this case, in an embodiment, one of the plurality of transfer modules (TFMs) may be the source transfer module (TFM), which is a transfer module (TFM) corresponding to a source task of the transfer learning according to an embodiment of the present disclosure.

In addition, among the remaining transfer modules (TFMs) excluding the source transfer module, any one of the transfer modules (TFMs) may be a target transfer module (TFM), which is a transfer module (TFM) corresponding to the target task of the transfer learning according to an embodiment of the present disclosure.

In addition, the inverse transfer module (ITM) according to an embodiment of the present disclosure may be a module that reconstructs the transfer vector mapped and transformed into a latent space of another task by a transfer module (TFM) so that the transfer vector is mapped back to the original latent space.

Thus, in an embodiment, the inverse transfer module (ITM) may generate a vector (hereinafter, an “inverse vector”) that reconstructs and transforms the transfer vector back to its original state.

In this case, the inverse transfer module (ITM) in an embodiment can improve the stability of the above-described reconstruction process and the accuracy and consistency of the corresponding transfer vector by utilizing the autoencoder structure.

In an embodiment, the inverse transfer module ITM may include the plurality of inverse transfer modules (ITMs), each corresponding to each of a plurality of domains.

As an example, the inverse transfer module (ITM) may include a first inverse transfer module corresponding to a first domain (for example, a boiling point), a second inverse transfer module corresponding to a second domain (for example, a melting point), . . . , and an n-th inverse transfer module corresponding to an n-th domain.

In this case, in an embodiment, one of the plurality of inverse transfer modules (ITMs) may be a source inverse transfer module, which is an inverse transfer module (ITM) corresponding to the source task of the transfer learning according to an embodiment of the present disclosure.

In addition, among the remaining inverse transfer modules (ITMs) excluding the source inverse transfer module, any one inverse transfer module (ITM) may be a target inverse transfer module (ITM), which is an inverse transfer module (ITM) corresponding to the target task of the transfer learning according to an embodiment of the present disclosure.

In this way, the multi-tasking learning model (MtLM) in an embodiment may form the latent space for each of the plurality of tasks performed based on the plurality of processing units (TPUs) by including the plurality of task processing units (TPUs) corresponding to the plurality of domains (that is, physical properties), respectively.

And the multi-tasking learning model (MtLM) can simultaneously train the transformation in which the plurality of formed latent spaces are converted into a single integrated latent space (M) according to the pre-training method described below.

In other words, the multi-tasking learning model (MtLM) may perform learning to geometrically align n latent spaces according to various physical properties into a single integrated latent space (M) through the pre-training method described below through the plurality of task processing units (TPUs).

Therefore, the multi-tasking learning model (MtLM) may implement simultaneous/batch transfer learning for n*n combinations of physical properties when n physical properties are considered.

Thus, the multi-tasking learning model (MtLM) according to an embodiment can improve prediction performance through information sharing and learning between interrelated physical properties/tasks.

In this case, the multi-tasking learning model (MtLM) in an embodiment may implement the transformation between the plurality of latent spaces and the integrated latent space (M) in the same way regardless of the composition of the physical property combination (for example, the first task-second task combination or the second task-third task combination, or the like).

In other words, the multi-tasking learning model (MtLM) may perform the transformation between the latent space and the integrated latent space (M) among the multiple tasks according to various physical properties in the same way.

Accordingly, the multi-tasking learning model (MtLM) may implement data processing that matches geometric properties based on latent vectors for the plurality of latent spaces in the same manner on the integrated latent space (M).

Through this, the multi-tasking learning model (MtLM) can effectively maintain the consistency of transformation from each latent space to the integrated latent space (M). Thus, the multi-tasking learning model (MtLM) can support the flow of mutual information between tasks more stably.

For example, the multi-tasking learning model (MtLM) can usefully use information acquired from the first task for the second task when the transformation from the latent space of the first task to the integrated latent space (M) and the transformation from the latent space of the second task to the integrated latent space (M) are mutually identical.

Therefore, the multi-tasking learning model (MtLM) can enhance the sharing of knowledge data between multiple tasks as well as improve the prediction performance and stability of the model.

Returning to FIG. 7 again, the perturbation module (PBM) according to an embodiment of the present disclosure may be a module that generates a plurality of perturbation vectors by applying a predetermined change to a predetermined embedding vector.

In detail, in an embodiment, the perturbation module (PBM) may be a module that generates the plurality of perturbation vectors (that is, perturbation points) around the corresponding embedding vector by applying a change that moves the specific embedding vector in a predetermined direction.

In this case, the plurality of generated perturbation vectors are designed to maintain a relative distance from the corresponding embedding vectors, thereby effectively assisting geometric alignment.

That is, the above-mentioned perturbation module (PBM) can help align the coordinate systems between the source task and the target task by generating the plurality of perturbation vectors to assist in the geometric alignment of the model.

In addition, in an embodiment, the perturbation module (PBM) may calculate the distance between the predetermined embedding vector and the plurality of perturbation vectors generated based on the embedding vector, and support matching the displacement between the source task and the target task based on the calculated distance.

This allows the perturbation module (PBM) to more easily maintain consistency in the latent space for the model.

According to an embodiment, the perturbation module (PBM) can prevent overfitting of the model and improve generalization performance by forcing the relationship between the predetermined embedding vector and the plurality of perturbation vectors generated based on the embedding vector to be maintained.

In addition, the loss calculation module (LCM) according to an embodiment of the present disclosure may be a module that calculates various loss functions based on various vectors acquired through the multi-tasking learning model (MtLM).

In an embodiment, the loss calculation module (LCM) may calculate a regression loss, autoencoder loss, consistency loss, mapping loss, distance loss, and/or integrated loss according to an embodiment of the present disclosure. A detailed description thereof will be provided later in a multi-tasking model training method.

Through this, the loss calculation module (LCM) may support regularization and learning for different parts of the model, and may implement model optimization by providing feedback for model learning.

Meanwhile, in an embodiment of the present disclosure, the multi-tasking learning model (MtLM) may perform model optimization and update through various data processing processes linked with the modules described above.

For example, the multi-tasking learning model (MtLM) may perform model optimization and parameter update in linkage with the modules described above based on the AdamW (Decoupled Weight Decay Regularization) optimization algorithm, or the like.

In this way, the multi-tasking learning model (MtLM) in an embodiment of the present disclosure may not only simultaneously train knowledge data according to various domains, but also efficiently learn relationships between the plurality of domains, thereby expanding the learning area and performing effective multi-tasking learning that implements batch learning of local patterns according to each domain and common principles between the plurality of domains.

Accordingly, the multi-tasking learning model (MtLM) can directly improve the processing performance and accuracy of various multi-tasking tasks based on the trained model as described above.

### [Method for Providing Multi-Tasking Model Pre-Training Service]

Hereinafter, a method for providing the multi-tasking model pre-training service that performs transfer learning through the geometric alignment in the integrated latent space for multiple tasks according to the plurality of domains by the computing system 1000 according to one embodiment of the present disclosure will be described in detail.

In general, existing transfer learning techniques are mainly focused on classification tasks of image and/or language data sets, and have limitations in solving regression problems or problems in non-Euclidean spaces.

In particular, in conventional transfer learning systems, when the training data set is insufficient, the degradation of prediction performance for the above-described problem is more inevitable, and when multitasking considering various task types is required, the degradation of performance in learning and prediction for this is aggravated.

Additionally, most of existing transfer learning methods are optimized for handling data in Euclidean space, and therefore do not work effectively in complex curved spaces or nonlinear spaces.

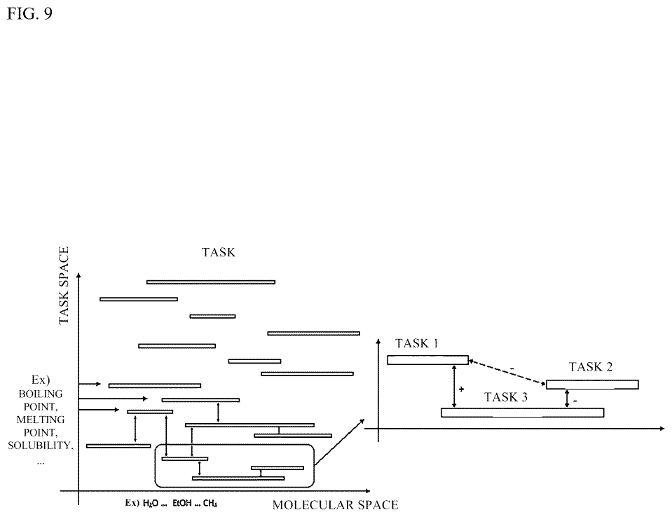

FIG. 9 illustrates a conceptual diagram for explaining a multi-tasking model training method according to one embodiment of the present disclosure.

As illustrated in FIG. 9, the computing system 1000 according to one embodiment of the present disclosure performs a new pre-training method and system for a multi-tasking model capable of overcoming the regression problem of a small data set and the limitations of existing transfer learning techniques.

Hereinafter, in the description according to one embodiment of the present disclosure, for effective explanation, the material described above is limited to a “molecule” and the domain thereof is explained based on a “physical property”.

This is because molecular data sets typically have small amounts of data, contain diverse task types, and primarily deal with regression problems.

That is, in the case of molecular data sets, various task processing linked to numerous physical properties is required, but the data given for this is very limited, and each physical properties have the characteristic of being closely related to or influencing each other.

Considering these issues, the molecular data set is advantageously applicable to multi-task processing according to the plurality of domains, and may be a preferable example for explaining the pre-training method and system for a multi-tasking model according to one embodiment of the present disclosure.

However, the present disclosure is not limited thereto, and any embodiment that can apply multiple tasks according to the plurality of domains can be included as an embodiment of the present disclosure.

Hereinafter, the pre-training method and system for a multi-tasking model according to one embodiment of the present disclosure will be described in more detail with reference to the drawings.

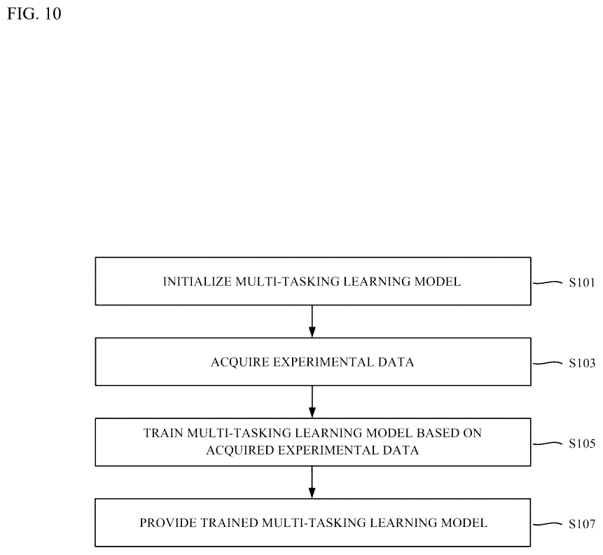

FIG. 10 illustrates a flowchart diagram for explaining a multi-tasking model training method according to one embodiment of the present disclosure.

Referring to FIG. 10, a pre-training method and system for a multi-tasking model according to one embodiment of the present disclosure may include Step S101 of initializing the multi-tasking learning model (MtLM), Step S103 of acquiring experimental data, Step (S105) of training the multi-tasking learning model (MtLM) based on the acquired experimental data, and Step S107 of providing a trained multi-tasking learning model (MtLM).

In detail, at step S101, the computing system 1000 according to one embodiment of the present disclosure may initialize the multi-tasking learning model (MtLM).

For example, the multi-tasking learning model (MtLM) (Geometrically Aligned Transfer Encoder Model) according to an embodiment of the present disclosure may be a machine learning model that mutually aligns fragmented knowledge data (for example, latent vectors, or the like) in each task's latent space through geometric transfer in a single integrated latent space (M) in order to process multiple tasks for output according to the plurality of domains.

That is, the multi-tasking learning model (MtLM) according to the embodiment may not only simultaneously train knowledge data according to various domains, but also efficiently train relationships between the plurality of domains, thereby expanding the learning area and simultaneously performing effective multi-tasking training that implements batch learning of local patterns according to each domain and common principles between the plurality of domains.

In detail, in an embodiment, the computing system 1000 may perform initialization for each component included in the multi-tasking learning model (MtLM) as described above.

As an example, the computing system 1000 may initialize an embedding network (embedd(X)), an encoder network (fₑ), a regressor (head) network (fₕ), a transfer network (fₜ), and/or an inverse network (fᵢ) within the multitask learning model (MtLM) with random parameters (θ).

Additionally, as an example, the computing system 1000 may set a predetermined optimization algorithm to be applied to the multi-tasking learning model (MtLM).

For example, the computing system 1000 may set the AdamW (Decoupled Weight Decay Regularization) algorithm as an optimization algorithm, and according to an embodiment, may improve and use the optimization algorithm to independently process weight decay.

In addition, at step S103, the computing system 1000 according to one embodiment of the present disclosure may acquire the experimental data.

Here, in other words, the experimental data (X) according to the embodiment of the present disclosure is training data used for training the multi-tasking learning model (MtLM), and may include predetermined input data and corresponding output data (that is, a label) information.

In an embodiment, the experimental data may be data including predetermined material-specific characteristic information and corresponding material-specific characteristic information. That is, in an embodiment, the experimental data may be data including predetermined material-specific characteristic information as input data and material-physical property specific information as output data (that is, a label) mapped to the input material-specific characteristic information.

In this case, the material-specific characteristic information according to an embodiment may be information specifying a unique characteristic possessed by a predetermined material. That is, the material-specific characteristic information in an embodiment may be information specifying a unique characteristic possessed by a predetermined molecule.

For example, the material-specific characteristic information may include at least one of data such as a predetermined material name, molecular structural formula, and/or chemical formula data, and in the following description, the material-specific characteristic information is limited to molecular structural formula data (for example, n (n≥2)-dimensional molecular structural formula) for explanation purposes only.

In addition, the material-physical property specific information according to an embodiment may be information that specifies a data value (that is, a characteristic value of the physical property, where the value includes a range) that a predetermined material has for a predetermined physical property.

For example, the material-physical property specific information may include physical properties (that is, a domain) of a predetermined material, such as a boiling point, melting point, refractive index, solubility, viscosity, surface tension, density, strength, and/or thermal conductivity.

In other words, in the examples below, the molecular structural formula data representing the material-specific characteristic information is used as input data, and the physical property value data for each task is used as output data.

In detail, in an embodiment, the computing system 1000 may acquire the experimental data as described above based on predetermined user input and/or linkage with an external server.

In more detail, in an embodiment, the computing system 1000 may acquire physical property relationship data indicating a relationship between predetermined physical properties.

Specifically, in an embodiment, the computing system 1000 may acquire the physical property relationship data based on user input (for example, input of data manually collected by the user, or the like) and/or linkage with a predetermined artificial intelligence model.

As an example, the computing system 1000 may acquire the physical property relationship data based on prompt engineering by linking with a large language model that has performed a predetermined pre-training.

In detail, the computing system 1000 may perform a data search based on keywords for physical properties in a database of specialized data (for example, papers, patents, and/or academic data) through a specific large language model.

Additionally, the computing system 1000 may extract at least one piece of information indicating a relationship between predetermined physical properties from the searched data.

Moreover, the computing system 1000 may perform an editing process of organizing and classifying the extracted physical property relationship information according to criteria, for example, physical property and/or relationship type.

Thus, the computing system 1000 may acquire physical property relationship data according to the edited information.

Additionally, in an embodiment, the computing system 1000 may generate a database of the acquired physical property relationship data.

In detail, the computing system 1000 according to an embodiment may include a physical property relationship data database.

Here, the above-described physical property relationship data database may store data including information on the relationships between predetermined physical properties.

These physical property relationship data databases may store data manually collected by people, or data automatically searched, extracted, and edited using pre-trained artificial intelligence models.

That is, in an embodiment, the computing system 1000 may store and manage the physical property relationship data acquired as described above in the physical property relationship data database.

Thus, the computing system 1000 may build the physical property relationship data database that includes information on the relationship between various physical properties.

Thereafter, in an embodiment, the computing system 1000 may acquire the physical property relationship information that specifies the relationship between different physical properties based on the physical property relationship data included in the physical property relationship data database.

As an example, the computing system 1000 may acquire at least one piece of physical property relationship information according to the predetermined physical property relationship data by linking with a large language model that has performed a predetermined pre-training.

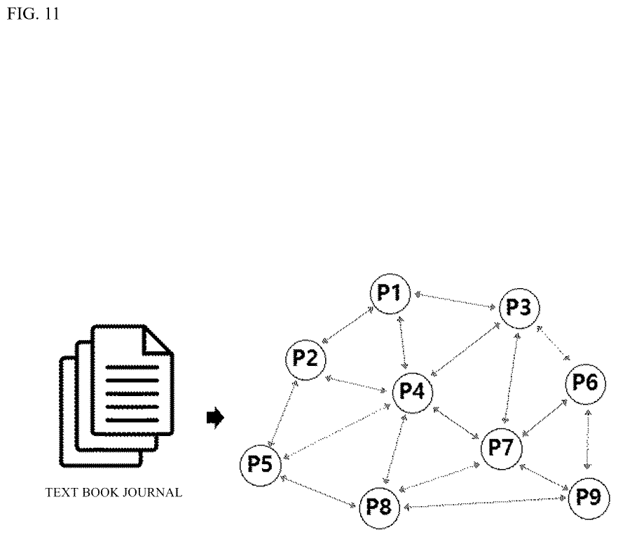

FIG. 11 illustrates a knowledge graph representing relationships between physical properties according to one embodiment of the present disclosure.

Referring to FIG. 11, the computing system 1000 may acquire a predetermined knowledge graph as the physical property relationship information, and at this time, the knowledge graph may include relationship information between the first to n-th physical properties, including relationship information between a first physical property P1 and a second physical property P2, relationship information between the first physical property P1 and a third property P3, or the like.

As a further specific example, the physical property relationship information as described above may include information about physical properties associated with a specific physical property, information about attributes (for example, conflict, similarity, correlation, cause and effect, independence, proportional, and/or inverse association relationships) of the association relationship, and/or information about the degree of association (association strength) according to attributes of the determined association relationship.

Here, the attributes of the association relationship (hereinafter, “physical property relationship attributes”) and the association degree information according to one embodiment may be divided into a numerical value indicating an association in a positive correlation and a numerical value indicating an association in a negative correlation and displayed on the knowledge graph.

Additionally, in an embodiment, the computing system 1000 may acquire the experimental data described above based on the acquired physical property relationship information.

That is, in an embodiment, the computing system 1000 may acquire the experimental data including predetermined material-specific characteristic information and corresponding material-specific characteristic information based on various physical property relationship information acquired as described above.

As an example, the computing system 1000 may acquire at least one experimental data according to the predetermined physical property relationship information by linking with a large language model that has performed predetermined pre-training.

In the above, it has been described that the computing system 1000 acquires experimental data through a predetermined data preprocessing based on the given physical property relationship information, but this is only an example, and various embodiments are possible, such as utilizing the given physical property relationship information itself as experimental data depending on an embodiment.

As a specific example, the computing system 1000 may acquire first experimental data including information on a first physical property for molecular structural formulas of a plurality of materials, second experimental data including information on a second physical property for molecular structural formulas of a plurality of materials, or the like.

Here, the plurality of materials corresponding to the first experimental data and the plurality of materials corresponding to the second experimental data, described above, may be different from each other or at least partially the same.

In this way, in an embodiment, the computing system 1000 may acquire the experimental data described above based on the relationship information between physical properties collected from data sources of various sources, thereby implementing model learning based on richer training data and minimizing errors due to data bias and data shortage problems.

Accordingly, the computing system 1000 can maximize the effect of various data sources to support the trained model to perform more accurate and reliable predictions, and can directly improve multi-task processing and prediction performance according to the plurality of physical properties.

In this case, in an embodiment of the present disclosure, the computing system 1000 may reflect the acquired physical property relationship information (for example, degree of association information, or the like) in the weight for at least one loss among various losses used in training the multi-tasking learning model (MtLM) in Step S205 described below.

That is, in an embodiment, the computing system 1000 can perform effective multi-tasking learning that implements batch learning of local patterns according to each domain (that is, properties) and common principles between the plurality of domains by reflecting physical property relationship information that specifies relationships between various physical properties.

Meanwhile, according to an embodiment, when the relationship between the predetermined first physical property and second physical property is expressed as a formula in the physical property relationship data database, the computing system 1000 may detect the relationship.

Moreover, the computing system 1000 may augment an experimental data set for training the multi-tasking learning model (MtLM) using the detected formula.

For example, the computing system 1000 may apply data augmentation based on a formula detected from a data set that only has the first physical property for a predetermined material to expand the data set to one that also considers the second physical property.

Alternatively, according to an embodiment, the computing system 1000 may optimize and update the multi-tasking learning model (MtLM) using the formula detected as above.

For example, the computing system 1000 may update the multi-tasking learning model (MtLM) to predict the second physical property by applying the detected formula to the first physical property when the multi-tasking learning model (MtLM) has trained only the first physical property of the first and second physical properties.

Alternatively, according to the embodiment, the computing system 1000 can improve the accuracy of integrated latent space (M) mapping during transfer learning for the multi-tasking learning model (MtLM) by using the detected formula.

For example, when the computing system 1000 trains both tasks of predicting the first physical property and the second physical property through the multi-tasking learning model (MtLM), the computing system 1000 may re-perform transfer learning between the model of the task of predicting the first physical property and the model of the task of predicting the second physical property based on the detected formula. Accordingly, the computing system 1000 can improve the integrated latent space (M) mapping optimization of the multi-tasking learning model (MtLM) to enhance its accuracy.

In addition, the computing system 1000 according to one embodiment of the present disclosure may train the multi-tasking learning model (MtLM) based on acquired experimental data (S105).

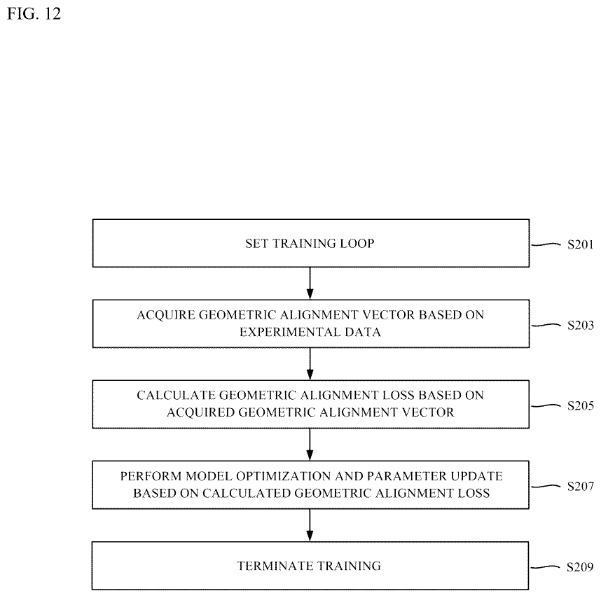

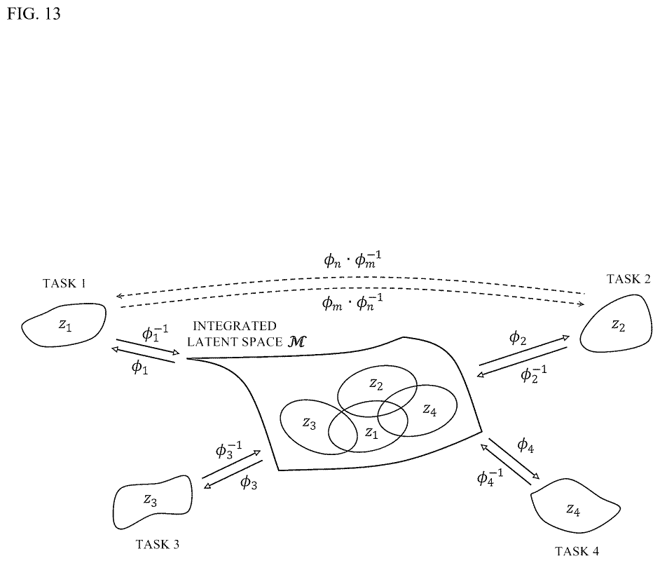

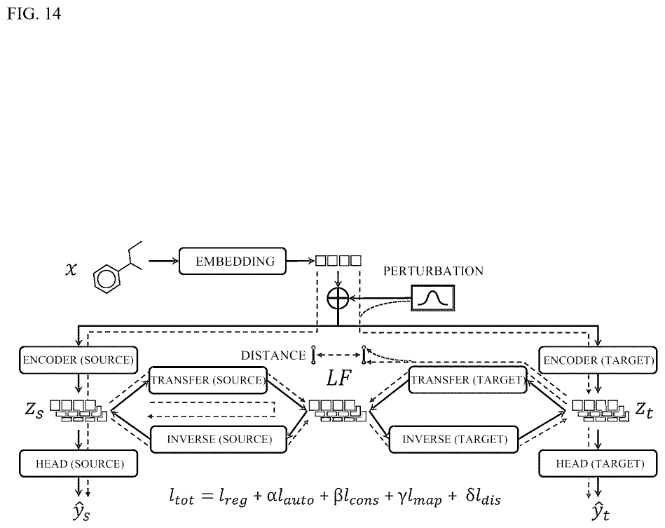

FIG. 12 illustrates a flowchart diagram for explaining a multi-tasking learning model (MtLM) training method according to one embodiment of the present disclosure, FIG. 13 illustrates a first conceptual diagram for explaining a training method of a multi-tasking learning model (MtLM) according to one embodiment of the present disclosure, and FIG. 14 illustrates a second conceptual diagram for explaining a training method of a multi-tasking learning model (MtLM) according to one embodiment of the present disclosure.

That is, referring to FIGS. 12 to 14, in an embodiment, the computing system 1000 may perform pre-training for the multi-tasking learning model (MtLM) based on the experimental data acquired as described above.

In this case, in an embodiment, the computing system 1000 may simultaneously train multiple tasks for predicting at least two domains (that is, physical properties) for the multi-tasking learning model (MtLM).

In detail, as an example, when a first task performing prediction on the first physical property is referred to as a source task and an n-th task performing prediction on an n-th (n≥2) physical property is referred to as a target task, the computing system 1000 may collectively perform transfer learning-based pre-training on the source task and the target task, and vice versa.

In other words, in an embodiment, the computing system 1000 may simultaneously perform the plurality of transfer learning according to n*n combinations between the first to n-th physical properties based on the multi-tasking learning model (MtLM) when considering n physical properties.

Therefore, the computing system 1000 according to an embodiment of the present disclosure can perform predictions for each physical property more accurately by allowing the multi-tasking learning model (MtLM) to naturally train correlations between physical properties trained together while training the plurality of physical properties through transfer learning.

As a specific example, the computing system 1000 can pre-train the relationship between the first to third physical properties in the multi-tasking learning model (MtLM) based on the experimental data including the relationship information between the first to third physical properties. Thereafter, the computing system 1000 can more accurately predict the relationship information between the first to third physical properties for a first material having only relationship information about the first and second physical properties by using the multi-tasking learning model (MtLM) pre-trained as described above.

In addition, through this, the computing system 1000 may implement the task processing that operates robustly to deformation of molecular structures and provides accurate prediction values for physical properties by training the multi-tasking learning model (MtLM) for various molecular structure types through transfer learning when the experimental data for each physical property includes data of different molecular structure types.

That is, the computing system 1000 according to an embodiment performs pre-training that batch-learns not only various physical property data but also relationships between the plurality of physical properties to the multi-tasking learning model (MtLM), thereby expanding the model learning area and simultaneously implementing effective multi-tasking learning that batch-learns local patterns according to each physical property and common principles between the plurality of physical properties.

Accordingly, the computing system 1000 can improve the performance and quality of processing various multi-tasking tasks based on the pre-trained multi-tasking learning model (MtLM) as described above, thereby expanding the range in which accurate prediction is possible.

Referring back to FIG. 12, in an embodiment, the computing system 1000 may perform pre-training based on transfer learning as described above according to the following process.

In detail, in an embodiment, at step S201, the computing system 1000 may set a training loop for the multi-tasking learning model (MtLM).

In more detail, in an embodiment, the computing system 1000 may set the number of epoch repetitions, the number of task repetitions, and/or the number of batch repetitions during training.

As an example, the computing system 1000 may set a training loop to repeatedly perform epoch “i” from “1 to n (n≥1)” during the training, repeatedly perform the same for each task “t”, and repeatedly perform the same for each preset batch “b”.

In addition, at step S203, in an embodiment, the computing system 1000 may acquire a geometric alignment vector based on the experimental data acquired as described above.

Here, the geometric alignment vector according to an embodiment of the present disclosure may mean various vectors acquired through the multi-tasking learning model (MtLM).

In an embodiment, the geometric alignment vector may include an embedding vector (α), a perturbation vector ({α̅}), an encoding vector, a transfer vector, and an inverse vector.

In detail, in an embodiment, the computing system 1000 may input the acquired experimental data into the multi-tasking learning model (MtLM).

In addition, in an embodiment, the computing system 1000 may acquire 1) the embedding vector based on the multi-tasking learning model (MtLM) that inputs experimental data.

In more detail, the computing system 1000 may transform the input experimental data into the embedding vector through an embedding network in linkage with the embedding module (EBM) of the multi-tasking learning model (MtLM).

Accordingly, the computing system 1000 may acquire the embedding vector transformed into a vector format by projecting the experimental data into a predetermined embedding space.

Additionally, in an embodiment, the computing system 1000 may generate 2) the perturbation vector based on the acquired embedding vector.

In detail, in an embodiment, the computing system 1000 may generate a plurality of perturbation vectors (that is, perturbation points) on a predetermined periphery based on the acquired embedding vector in linkage with a perturbation module (PBM) of the multi-tasking learning model (MtLM).

In this case, in an embodiment, the computing system 1000 may repeatedly perform the above-described functional operation for each task to acquire the corresponding perturbation vector for each task.

As an example, the computing system 1000 may acquire a plurality of task-specific perturbation vectors, including a perturbation vector corresponding to task “t” and a perturbation vector corresponding to task “s”.

Additionally, in an embodiment, the computing system 1000 may acquire encoding vectors, transfer vectors, and inverse vectors based on the generated perturbation vectors and embedding vectors.

In detail, referring further to FIG. 8, FIG. 13 and FIG. 14, in an embodiment, the computing system 1000 may be collectively linked with a plurality of task processing units (TPUs) included in the multi-tasking learning model (MtLM) to acquire the encoding vector, the transfer vector, and the inverse vector for each task processing unit (TPU).

That is, the computing system 1000 may acquire the plurality of encoding vectors, transfer vectors, and inverse vectors for each task processed in each task processing unit (TPU) by being collectively linked with the plurality of task processing units (TPUs) each corresponding to the plurality of physical properties (that is, domains) to be predicted.

Hereinafter, for effective explanation, a method of acquiring the vectors based on a task “t” processed in a first task processing unit (TPU) and a task “s” processed in a second task processing unit (TPU) is described. However, the plurality of task processing units (TPUs) described above may all acquire the vectors for each task corresponding to each unit in the same manner as the method described below.

In detail, in an embodiment, the computing system 1000 may acquire 3) the encoding vector based on the generated perturbation vector and embedding vector.

Here, the encoding vector according to an embodiment may include a perturbation latent vector, which is a latent vector generated based on a predetermined perturbation vector, and an original latent vector generated based on the embedding vector, which is an original vector of the perturbation vector.

In more detail, in an embodiment, the computing system 1000 may project the generated perturbation vector into the latent space corresponding to the task through an encoder network by linking with the encoder module (ECM) included in the first and second task processing units (TPUs) (hereinafter, “training task processing units”) of the multi-tasking learning model (MtLM) to transform the generated perturbation vector into the latent vector.

In addition, in an embodiment, the computing system 1000 may transform the acquired embedding vector into the latent vector by projecting the embedding vector into the latent space corresponding to the task through an encoder network in linkage with the encoder module (ECM) of the multi-tasking learning model (MtLM).

Thus, in an embodiment, the computing system 1000 may acquire the perturbation potential vector and the original potential vector.

In this case, in an embodiment, the computing system 1000 may repeatedly perform the above-described functional operation for each task to acquire the original potential vector and the perturbation potential vector corresponding to each task.

As an example, the computing system 1000 may acquire the original latent vector (hereinafter, a “t original latent vector”) corresponding to task “t” and a perturbation latent vector (hereinafter, a “t perturbation latent vector”) corresponding to task “t”.

In addition, the computing system 1000 may acquire an original latent vector (hereinafter, a “s original latent vector”) corresponding to task “s” and a perturbation latent vector (hereinafter, a “s perturbation latent vector”) corresponding to task “s”.

Additionally, in an embodiment, the computing system 1000 may acquire 4) the transfer vector based on the acquired encoding vector.

Here, the transfer vector according to an embodiment may include a perturbation transfer vector, which is a transfer vector generated based on a predetermined perturbation potential vector, and an original transfer vector, which is a transfer vector generated based on the original potential vector corresponding to the perturbation potential vector.

In detail, in an embodiment, the computing system 1000 may transform the acquired perturbation latent vector and original latent vector into the transfer vector by mapping them to the latent space of another task (in an embodiment, task “s” or task “t”) through the transfer network in linkage with the transfer module (TFM) included in the training task processing unit of the multi-tasking learning model (MtLM).

Thus, the computing system 1000 may acquire the perturbation transfer vector and the original transfer vector.

In this case, in an embodiment, the computing system 1000 may repeatedly perform the above-described functional operation for each task to acquire the corresponding original transfer vector and the perturbation transfer vector for each task.

As an example, the computing system 1000 may acquire an original transfer vector (hereinafter, a “t original transfer vector”) corresponding to task “t” and a perturbation transfer vector (hereinafter, a “t perturbation transfer vector”) corresponding to task “t”.

In addition, the computing system 1000 may acquire an original transfer vector (hereinafter, s original transfer vector) corresponding to the task “s” and a perturbation transfer vector (hereinafter, s perturbation transfer vector) corresponding to the task “s”.

Thus, in an embodiment, the computing system 1000 may acquire the geometric alignment vectors (that is, embedding vectors, perturbation vectors, encoding vectors (including original latent vectors and perturbation latent vectors), and transfer vectors (including original transfer vectors and perturbation transfer vectors) based on the experimental data.

Additionally, in an embodiment, the computing system 1000 may acquire 5) the inverse vector based on the acquired transfer vector.

Here, the inverse vector according to an embodiment may include a perturbation inverse vector, which is an inverse vector generated based on a predetermined perturbation transfer vector, and an original inverse vector, which is an inverse vector generated based on an original transfer vector corresponding to the perturbation transfer vector.

For example, in an embodiment, the computing system 1000 may reconstruct the acquired perturbation transfer vector and the original transfer vector through the inverse network so as to be mapped back to the original latent space and transform them into an inverse vector in linkage with the inverse transfer module (ITM) included in the training task processing unit of the multi-tasking learning model (MtLM).

Thus, the computing system 1000 may acquire the perturbation inverse vector and the original inverse vector.

In this case, in an embodiment, the computing system 1000 may repeatedly perform the above-described functional operation for each task to acquire the original inverse vector and the perturbation inverse vector corresponding to each task.

As an example, the computing system 1000 may acquire an original inverse vector (hereinafter, a “t original inverse vector”) corresponding to task “t” and a perturbation inverse vector (hereinafter, a “t perturbation inverse vector”) corresponding to task “t”.

In addition, the computing system 1000 may acquire an original inverse vector (hereinafter, a “s original inverse vector”) corresponding to task “s” and a perturbation inverse vector (hereinafter, a “s perturbation inverse vector”) corresponding to task “s”.

Thus, in an embodiment, the computing system 1000 may acquire the geometric alignment vectors (that is, embedding vectors, perturbation vectors, encoding vectors (including original latent vectors and perturbation latent vectors), transfer vectors (including original transfer vectors and perturbation transfer vectors), and inverse vectors (including original inverse vectors and perturbation inverse vectors), or the like) based on the experimental data.

Additionally, at step S205, in an embodiment, the computing system 1000 may calculate a geometric alignment loss based on the acquired geometric alignment vector.

Here, the geometric alignment loss according to an embodiment of the present disclosure may mean various loss functions calculated based on various vectors (that is, geometric alignment vectors) acquired through the multi-tasking learning model (MtLM).

In an embodiment, the geometric alignment loss may include a regression loss, an autoencoder loss, a consistency loss, a mapping loss, a distance loss, and/or an integrated loss.

In detail, in an embodiment, the computing system 1000 may calculate the geometric alignment loss based on the geometric alignment vectors (that is, geometric alignment vectors for each of the plurality of task processing units (TPUs) and the plurality of tasks processed by the task processing units (TPUs)) acquired as described above.

As described above, for effective explanation, a method for calculating the geometric alignment loss is described below based on task “t” processed in the first task processing unit (TPU) and task “s” processed in the second task processing unit (TPU) (especially, with more emphasis on task “t”).

In this case, in an embodiment, the computing system 1000 may train the multi-tasking learning model (MtLM) by reflecting the physical property relationship information described in the above-described Step S103 to the weight for at least one loss among various losses included in the geometric alignment loss.

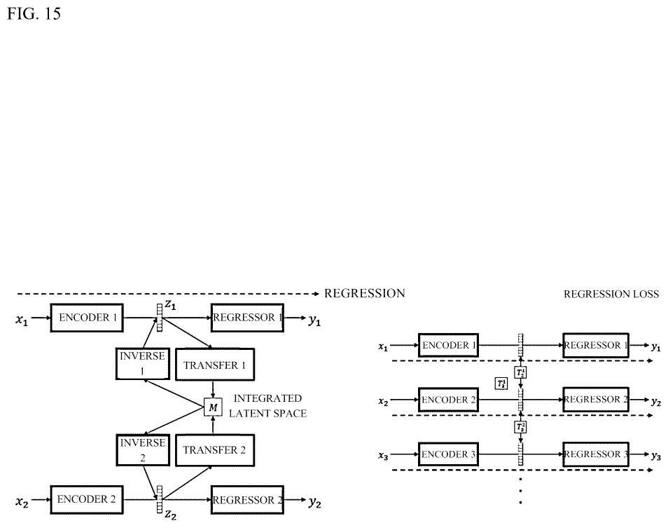

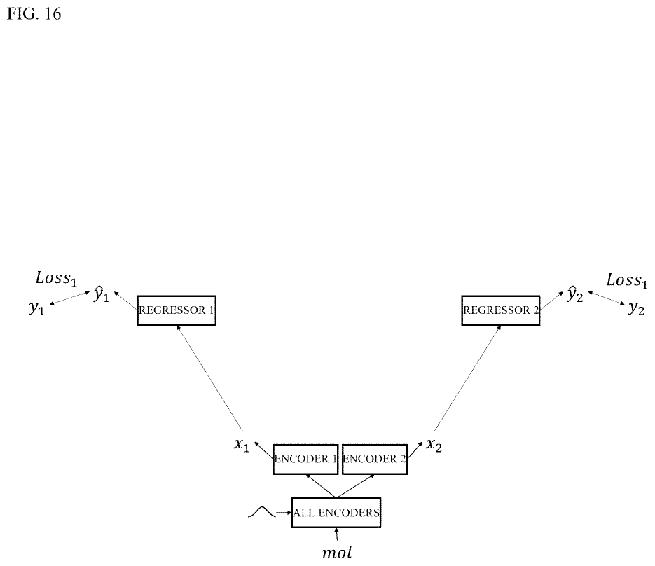

FIGS. 15 and 16 illustrate diagrams for explaining a regression loss calculation method according to one embodiment of the present disclosure.

Referring to FIGS. 14 to 16, in an embodiment, the computing system 1000 may calculate 1) the regression loss based on the multi-tasking learning model (MtLM) that has acquired the geometric alignment vector.

In more detail, in an embodiment, the computing system 1000 may calculate a regression loss based on a predicted value ( [symbol] ) and an actual value ( [symbol] , that is, a label value) predicted through the regression module (RGM) according to Mathematical Expression 1 below. Here, the predicted value of Mathematical Expression 1 may be expressed as “fₕ(zₜ)”.

$${L}_{reg} = M S E ( {t}_{} , {y}_{t} ) \qquad [ Mathematical Expression 1 ]$$

That is, the computing system 1000 may calculate the regression loss by calculating a mean squared error (MSE) between the predicted value and the actual value.

In this case, in an embodiment, each task may prevent mutual interference by calculating an independent regression loss based on the encoder module (ECM) and the regressor module (RGM) matching each task and performing learning based on the regression loss.

In this way, the computing system 1000 can easily evaluate the regression performance of the model by calculating the regression loss.

In addition, referring to FIG. 14, in an embodiment, the computing system 1000 may calculate 2) the autoencoder loss based on the multi-tasking learning model (MtLM) that has acquired a geometric alignment vector.

In detail, in an embodiment, the computing system 1000 may calculate the autoencoder loss based on the original latent vector and the original inverse vector according to Mathematical Expression 2.

$${L}_{auto} = M S E ( {\hat{𝓏}}_{t} , {𝓏}_{t} ) \qquad [ Mathematical Expression 2 ]$$

That is, the computing system 1000 may calculate the autoencoder loss by calculating the mean square error (MSE) between the latent vector and the inverse vector.

In an embodiment, the computing system 1000 can improve accuracy in the data transfer process through the autoencoder loss calculated as described above.

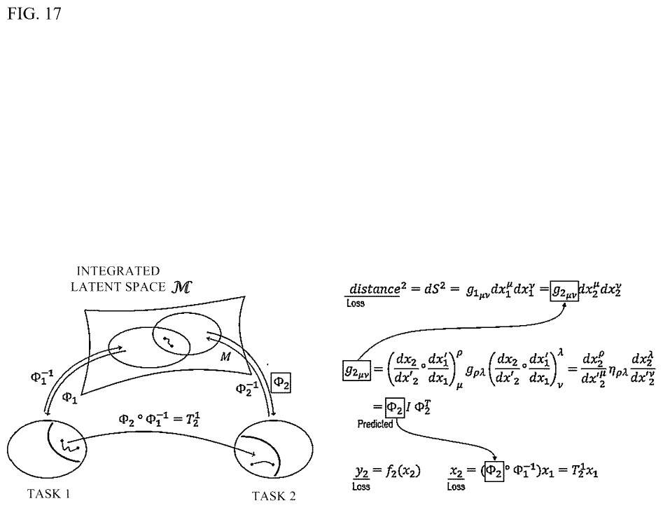

FIG. 17 illustrates a diagram for explaining an integrated latent space (M) mapping method according to one embodiment of the present disclosure.

Referring to FIG. 17, in an embodiment, the computing system 1000 may train a bidirectional transformation matrix (TM) that can be mapped to a common integrated latent space (M) for each task.

In detail, in an embodiment, the computing system 1000 may connect the latent spaces between tasks by utilizing knowledge data that contains labels for both tasks.

In this process, the computing system 1000 may calculate the consistency loss and mapping loss according to an embodiment.

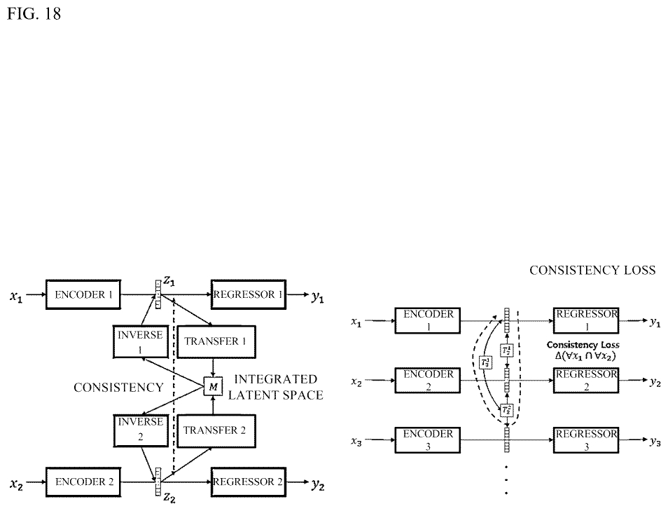

FIGS. 18 and 19 illustrate diagrams for explaining a consistency loss calculation method according to one embodiment of the present disclosure.

In more detail, referring to FIGS. 14, 18 and 19, in an embodiment, the computing system 1000 may calculate 3) the consistency loss based on the multi-tasking learning model (MtLM) that has acquired a geometric alignment vector.

Specifically, in an embodiment, the computing system 1000 may calculate the consistency loss based on the perturbation transfer vector of task “t” and the perturbation transfer vector of task “s” according to Mathematical Expression 3.

$${L}_{cons} = M S E ( \{ {\overline{m}}_{s} \} , \{ {\overline{m}}_{t} \} ) \qquad [ Mathematical Expression 3 ]$$

That is, the computing system 1000 may calculate the consistency loss by calculating the mean square error (MSE) between the t perturbation transfer vector and the s perturbation transfer vector.

In this case, in an embodiment, the computing system 1000 may derive a metric for calculating a distance in space from a transformation matrix (TM), and train to make the distance in the latent space of each task the same based on the derived metric.

Through this, the computing system 1000 can more effectively implement the geometric alignment between tasks.

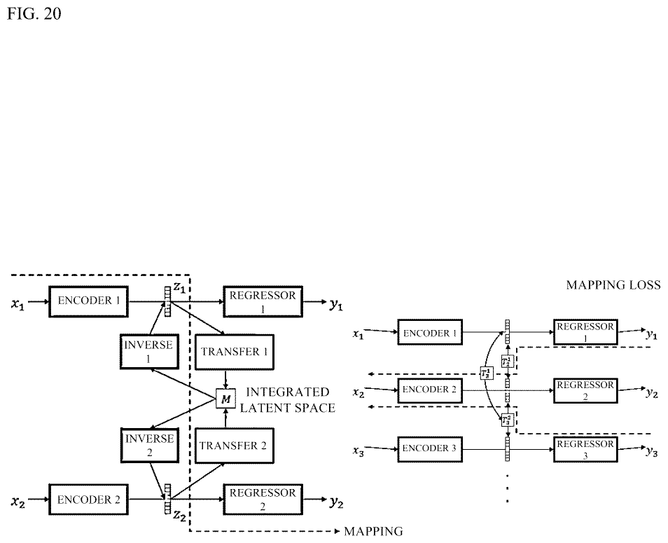

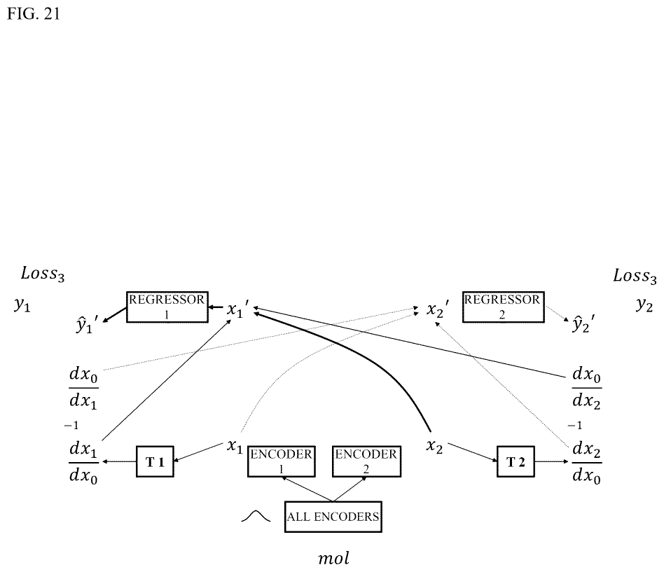

FIGS. 20 and 21 illustrate diagrams for explaining a mapping loss calculation method according to one embodiment of the present disclosure.

Referring to FIGS. 14, 20, and 21, in an embodiment, the computing system 1000 may calculate 4) the mapping loss based on the multi-tasking learning model (MtLM) that has acquired the geometric alignment vector.

In detail, in an embodiment, the computing system 1000 may calculate the mapping loss based on the predicted value based on the actual value according to task “t” and the original inverse vector according to task “s” according to Mathematical Expression 4.

$${L}_{map} = M S E ( {f}_{h} ( {f}_{i} ( {m}_{s} ) ) , {t}_{} ) \qquad [ Mathematical Expression 4 ]$$

That is, the computing system 1000 may calculate the mapping loss by calculating the mean square error (MSE) between the actual value of task “t” and the predicted value according to the original inverse vector of task “s”.

In an embodiment, the computing system 1000 can implement training to transfer the latent vector from a latent space of one task to a latent space of the other task by calculating the mapping loss as described above, and perform the other task based on the transferred vectors, thereby inducing latent characteristics to become similar to each other.

Through this, the computing system 1000 may induce the learning in the direction of evaluating the prediction performance of the vector transferred to the latent space of another task and improving the prediction performance.

In addition, referring to FIG. 14, in an embodiment, the computing system 1000 may calculate 5) the distance loss based on the multi-tasking learning model (MtLM) that has acquired the geometric alignment vector.

In detail, in an embodiment, the computing system 1000 may calculate the distance loss between tasks based on the distance (hereinafter, “transfer vector displacement”) between the original transfer vector and the perturbation transfer vector of each task according to Mathematical Expressions 5 and 6 below.

In more detail, in an embodiment, the computing system 1000 may calculate the distance (hereinafter, “t transfer vector displacement”) between the t original transfer vector and the t perturbation transfer vector according to task “t” according to (a) of Mathematical Expression 5 below.

In addition, the computing system 1000 may calculate the distance (hereinafter, “s transfer vector displacement”) between the s original transfer vector and the s transformation transfer vector according to task “s” according to (b) of the Mathematical Expression 5 below.

$$[ Mathematical Expression 5 ]$$

$${s}_{i}^{s} = {m}_{t} - \{ {\overline{m}}_{t} \} \qquad ( a )$$

$${s}_{i}^{t} = {m}_{s} - \{ {\overline{m}}_{s} \} \qquad ( b )$$

In addition, in an embodiment, the computing system 1000 may calculate the mean square error (MSE) between the t transfer vector displacement and the s transfer vector displacement according to Mathematical Expression 6 to calculate the distance loss.

$${L}_{dis} = \frac{1}{M} {\sum }_{i} M S E ( {s}_{i}^{s} , {s}_{i}^{t} ) \qquad [ Mathematical Expression 6 ]$$

Here, “M” in Mathematical Expression 6 means the number of perturbation points.

In this case, in an embodiment, the computing system 1000 may define each of the t transfer vector displacement and the s transfer vector displacement as displacements in the source task and the target task.

Thus, the computing system 1000 may more easily calculate the distance between the original transfer vector and the perturbation transfer vector by interpreting the t transfer vector displacement and the s transfer vector displacement as being in a flat Euclidean space.

Therefore, the computing system 1000 can support more complete maintenance of consistency for the latent space of the model.

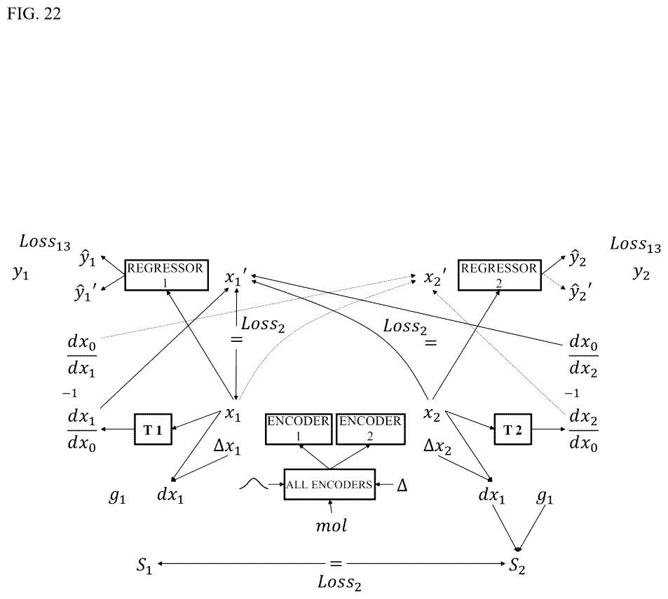

FIG. 22 illustrates a diagram for explaining an integrated loss calculation method according to one embodiment of the present disclosure.

Referring to FIGS. 14 and 22, in an embodiment, the computing system 1000 may calculate 6) the integrated loss based on the multi-tasking learning model (MtLM) that has acquired the geometric alignment vector.

In detail, in an embodiment, the computing system 1000 may calculate an integrated loss by weighting the regression loss, autoencoder loss, consistency loss, mapping loss, and distance loss described above according to Mathematical Expression 7 below.

$${L}_{tot} = {L}_{reg} + α {L}_{auto} + β {L}_{cons} + γ {L}_{map} + δ {L}_{dis} \qquad [ Mathematical Expression 7 ]$$

In this case, in an embodiment, the computing system 1000 may apply weights to each loss function so that each loss function can be optimized for a specific aspect of the model.

Here, in Mathematical Expression 7, “α” is the weight of the autoencoder loss, “β” is the weight of the consistency loss, “γ” is the weight of the mapping loss, and “δ” is the weight of the distance loss.

In an embodiment, the computing system 1000 may update parameters in order to minimize the integrated loss by adjusting the importance of the loss function corresponding to each weight during the training process of the model by utilizing the above weights.

In this case, in an embodiment, the computing system 1000 may adjust the weight for at least one loss of the integrated loss according to the physical property relationship information acquired in Step S103.

As an example, the computing system 1000 may determine or correct the value of the weight of the mapping loss, which is a loss that supports learning of relationships between physical properties, by reflecting the above-described physical property relationship information.

As a specific example, the computing system 1000 may reflect the physical property relationship information by increasing the weight of the mapping loss and reinforcing learning according to the mapping loss when the first and second physical properties are correlated and have a high degree of mutual correlation.

As another example, the computing system 1000 may reflect the physical property relationship information in a manner that reduces the weight of the mapping loss to weaken learning according to the mapping loss when the first physical property and the second physical property are not correlated or have a low degree of correlation.

Accordingly, the computing system 1000 according to an embodiment of the present disclosure may more accurately apply the relationship information between physical properties detected from various sources of pre-studied expert data to multi-tasking learning model (MtLM) training.

Returning to FIG. 12, at step S207, in an embodiment, the computing system 1000 may perform model optimization and parameter update based on the geometric alignment loss calculated as described above.

In detail, in an embodiment, the computing system 1000 may perform the optimization and parameter update for the multi-tasking learning model (MtLM) based on the integrated loss described above.

As an example, the computing system 1000 may calculate a gradient based on the integrated loss for each parameter of the multi-tasking learning model (MtLM) through backpropagation.

Moreover, the computing system 1000 may perform the parameter update of the multi-tasking learning model (MtLM) using the calculated gradient and a preset optimization algorithm (for example, the AdamW (Decoupled Weight Decay Regularization) algorithm, or the like).

Thus, the computing system 1000 may implement the multi-tasking learning model (MtLM) optimization based on the geometric alignment loss (in particular, integration loss).

In this way, in an embodiment, the computing system 1000 may perform the multi-tasking learning model (MtLM) optimization and the parameter update learning through a combination of the plurality of loss functions calculated in various ways.

In this case, each loss function can easily assist in improving the performance of the model by correcting the accuracy, consistency, and/or distance of knowledge data mapping.

Through this, the computing system 1000 may implement the multi-tasking model that provides improved performance that overcomes the regression problem of a small data set and the limitations of existing transfer learning techniques, while operating more stably and providing improved generalization performance.

Additionally, at step S209, in an embodiment, the computing system 1000 may terminate the multi-tasking learning model (MtLM) training.

In detail, in an embodiment, the computing system 1000 may terminate the multi-tasking learning model (MtLM) training process described above when a preset training termination condition is met.

In an embodiment, the computing system 1000 may terminate multi-tasking learning model (MtLM) training upon the completion of the set training loop.

In this way, in an embodiment, the computing system 1000 may cause the multi-tasking learning model (MtLM) simultaneously to train the prediction tasks for at least two physical properties, thereby allowing the multi-tasking learning model (MtLM) to naturally train correlations between physical properties trained together while training the plurality of physical properties through transfer learning, thereby enabling predictions for each physical property to be performed more accurately.

Through this, the computing system 1000 may implement the task processing that operates robustly to deformation of molecular structures and provides accurate prediction values for physical properties by training the multi-tasking learning model (MtLM) for various molecular structure types through transfer learning when experimental data for each physical property includes data of different molecular structure types.

That is, the computing system 1000 according to an embodiment performs pre-training that causes the multi-tasking learning model (MtLM) to batch-learn not only various physical property data but also relationships between the plurality of physical properties, thereby expanding the model learning area and implementing effective multi-tasking training that simultaneously or collectively trains local patterns according to each physical property and common principles between the plurality of physical properties.

Accordingly, the computing system 1000 can improve the performance and quality of processing various multi-tasking tasks based on the pre-trained multi-tasking learning model (MtLM) as described above, thereby expanding the range in which accurate prediction is possible.

Returning to FIG. 10, at step S107, the computing system 1000 according to one embodiment of the present disclosure may also provide the trained multi-tasking learning model (MtLM).

That is, in an embodiment, the computing system 1000 may provide the multi-tasking learning model (MtLM) trained as described above in a predetermined manner.

As an embodiment, the computing system 1000 may provide the multi-tasking learning model (MtLM) trained according to an embodiment of the present disclosure in linkage with a predetermined application service (for example, a subject material synthesis and/or evaluation service, a physical property prediction service, and/or an optimal material recommendation service).

Specifically, according to an embodiment, the computing system 1000 may provide the multi-tasking learning model (MtLM) through an operation that, when a predetermined molecular structural formula is input, inputs the molecular structural formula into the multi-tasking learning model (MtLM) and outputs the physical property values for each of a plurality of domains (that is, physical properties) that the multi-tasking learning model (MtLM) has pre-trained. In this case, each physical property value may be provided in the form of a physical property value with the highest probability and/or a physical property value range for a specific probability.

Conversely, according to an embodiment, the computing system 1000 may provide the multi-tasking learning model (MtLM) through the operations of reverse-engineering a pre-trained multi-tasking learning model (MtLM), receiving physical property values for the plurality of physical properties, inputting the corresponding physical property values into the reverse-engineered multi-tasking learning model (MtLM), and outputting at least one molecular structural formula that satisfies the physical property values.

In this way, the computing system 1000 can effectively support various multi-tasking task processing in various ways by using the multi-tasking learning model (MtLM) with improved performance according to an embodiment of the present disclosure.

As described above, in an embodiment of the present disclosure, the computing system 1000 can provide the multi-tasking learning model (MtLM) that operates more stably while providing improved performance that overcomes the regression problem of a small data set and the limitations of existing transfer learning techniques by mutually transferring and training knowledge data of latent spaces for each task through geometric alignment in a single integrated latent space in order to process multiple tasks for output according to the plurality of domains.

Through this, the computing system 1000 can provide a transfer learning-based multi-tasking model that operates stably and robustly while exhibiting high generalization performance even in situations where the amount of given data is small, various task types are included, or regression problems are mainly dealt with.

In other words, the computing system 1000 can provide the multi-tasking learning model (MtLM) with improved prediction performance based on knowledge distilled through the geometric alignment-based transfer learning performed in linkage with other domains, even when there is a domain of the plurality of domains (in an embodiment, physical properties) that lacks the experimental data (training data).

For example, the computing system 1000 pre-trains the multi-tasking learning model (MtLM) based on the first to tenth physical properties for each of the plurality of molecular structural formulas, and then, when a first molecular structural formula including only data for the first to fifth physical properties is input, the computing system 1000 can more accurately predict the predicted values for the remaining sixth to tenth physical properties for the first molecular structural formula based on the knowledge data transferred and distilled through the pre-training, and generate and provide output data based thereon.

In this way, the computing system 1000 according to an embodiment of the present disclosure can provide the multi-tasking model that implements effective transfer learning based on the geometric alignment, guarantees high generalization performance, improves prediction accuracy for regression problems, supports regularization according to a combination of various loss functions, and performs a stable training process to guarantee robust performance.

Meanwhile, according to an embodiment, the computing system 1000 may perform a method of providing a guide that supports performance improvement of a multi-tasking model by providing the multi-tasking learning model (MtLM) trained according to an embodiment of the present disclosure in linkage with a predetermined application service.

In other words, the computing system 1000 can provide a service (hereinafter, a “multi-tasking model guide provision service”) that provides a guide to support performance improvement of a predetermined multi-tasking model by using the multi-tasking learning model (MtLM) according to an embodiment of the present disclosure.

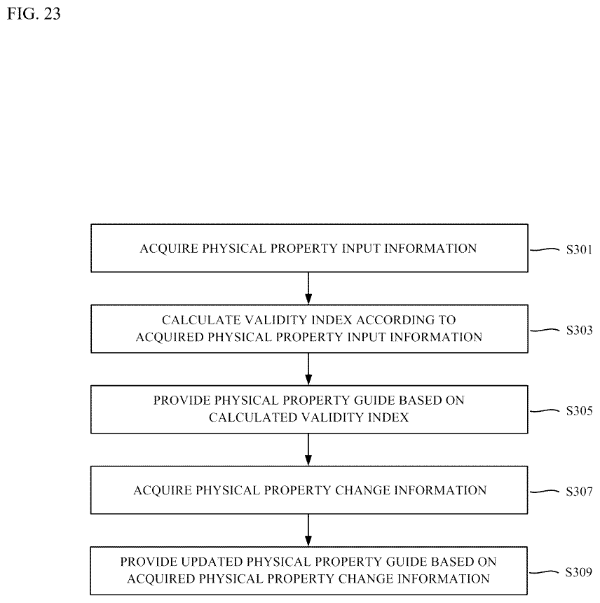

FIG. 23 illustrates a flowchart diagram for explaining a method for providing a guide to support performance improvement of a multi-tasking model according to one embodiment of the present disclosure.

Referring to FIG. 23, at step S301, the computing system 1000 according to one embodiment of the present disclosure may acquire predetermined physical property input information.

For instance, the physical property input information according to the embodiment may be information acquired based on user input regarding characteristic values (that is, physical property values) for each of N (1≤N<T) physical properties (that is, N-dimensional physical properties).

In detail, in an embodiment, the computing system 1000 may acquire physical property input information including N physical property values (that is, target physical property values) based on user input based on a predetermined user interface.

That is, the computing system 1000 may acquire physical property input information that specifies physical property values that the user wants to satisfy for the output data (in an embodiment, molecular structural formula data, or the like) of the multi-tasking learning model (MtLM).

At step S303, the computing system 1000 according to one embodiment of the present disclosure may calculate a validity index according to the acquired physical property input information.

Here, the validity index according to an embodiment may mean data that quantitatively evaluates the difficulty of generating output data (in an embodiment, molecular structural formula data, or the like) generated based on predetermined input data (in an embodiment, physical property input information, or the like).

That is, in an embodiment, the validity index may be data that numerically expresses the actual feasibility (generation probability) of molecular structural formula data generated based on predetermined physical property input information.

For example, the validity index according to an embodiment may be set inversely proportional to the difficulty of generation. That is, in an embodiment, the validity index may be lowered as the difficulty of generation increases and the validity index may be higher as the difficulty of generation decreases.

In an embodiment, these validity indexes may include first to third validity indexes based on a predetermined density estimation algorithm, a fourth validity index based on a predetermined anomaly detection algorithm, and/or a fifth validity index based on a similarity determination algorithm.

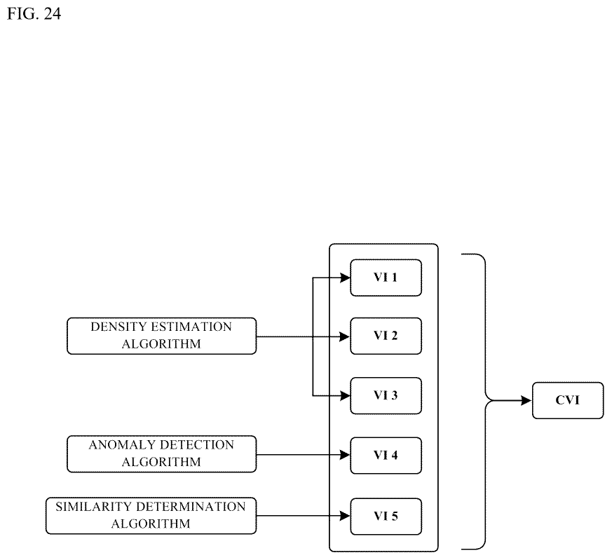

FIG. 24 illustrates a diagram for explaining a validity index according to one embodiment of the present disclosure.

Referring to FIG. 24, in an embodiment, the computing system 1000 may calculate the validity index for the acquired physical property input information using various deep learning algorithms.

In this case, in an embodiment, the computing system 1000 may calculate a validity index for the physical property input information by using at least some of the various deep learning algorithms described below.

In addition, various deep learning algorithms used in an embodiment may be directly included and operated in the multi-tasking learning model (MtLM), or may be implemented and operated separately from the multi-tasking learning model (MtLM).

In more detail, as an example, the computing system 1000 may calculate 1) a validity index based on a density estimation algorithm.

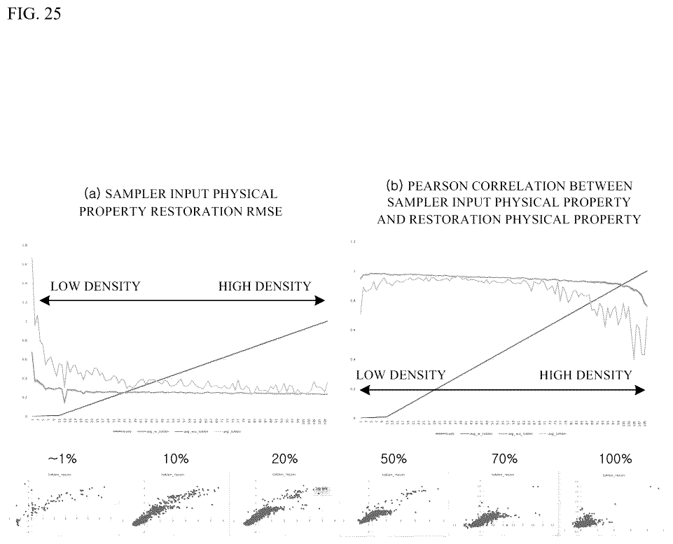

FIG. 25 illustrates a diagram for explaining the background of utilization of a density estimation algorithm according to one embodiment of the present disclosure.

(a) of FIG. 25 illustrates a graph visualizing a root mean square error (RMSE) relationship that occurs in the process of restoring given physical property input information by a sampler module (SPM) according to an embodiment of the present disclosure.

Here, an x-axis of the graph in (a) of FIG. 25 represents data density (higher density toward the right), and a y-axis represents the RMSE value.

Referring to (a) of FIG. 25, there is a tendency for the RMSE value to be high in low-density areas. Therefore, it may be difficult to perform accurate restoration in areas with little or unbalanced training data.

Meanwhile, in high-density areas, the RMSE value is lower, and the restoration tends to be more accurate than in low-density areas. Accordingly, the restoration performance may be improved in areas where there is sufficient training data.

That is, as illustrated in (a) of FIG. 25, the model's restoration performance deteriorates in areas where the density of training data is low, whereas the model's restoration performance improves in areas where the density of training data is high.

Meanwhile, (b) of FIG. 25 illustrates a graph visualizing a Pearson correlation coefficient relationship between input data (that is, physical property input information) and restoration data (that is, high-dimensional latent variables) of a sampler module (SPM) according to one embodiment of the present disclosure.

Here, an x-axis of the graph of (b) of FIG. 25 represents data density (higher density toward the right), and a y-axis represents the Pearson correlation coefficient value.

Referring to (b) of FIG. 25(b), the Pearson correlation coefficient tends to be low in low-density areas. Accordingly, the correlation between input physical properties and restoration physical properties may be low in areas where training data is insufficient.

Meanwhile, in the high-density region, the Pearson correlation coefficient value increases and the correlation between the input physical properties and the restoration physical properties tends to increase. This can indicate that the model has trained well in the region where there is sufficient training data.

That is, through (b) of FIG. 25, in areas where the density of training data is low, the prediction accuracy of the model is reduced, whereas in areas where the density of training data is high, the prediction performance of the model is improved (that is, the input physical properties are restored with higher accuracy).

As can be seen in (a) and (b) of FIG. 25, the lower the data density, the higher the difficulty in generating output data (for example, molecular structure data, or the like), and it can be confirmed that there is some correlation between the density of input physical properties (that is, low-dimensional data) and the density of restoration physical properties (that is, high-dimensional data).

In view of the above points, the computing system 1000 according to an embodiment of the present disclosure can calculate the validity index for given data (in an embodiment, the degree of physical property input) by considering the density of the data.

Specifically, in an embodiment, the computing system 1000 may calculate 1) a first validity index (VI 1), which is the validity index based on the physical property input information, based on the density estimation algorithm.

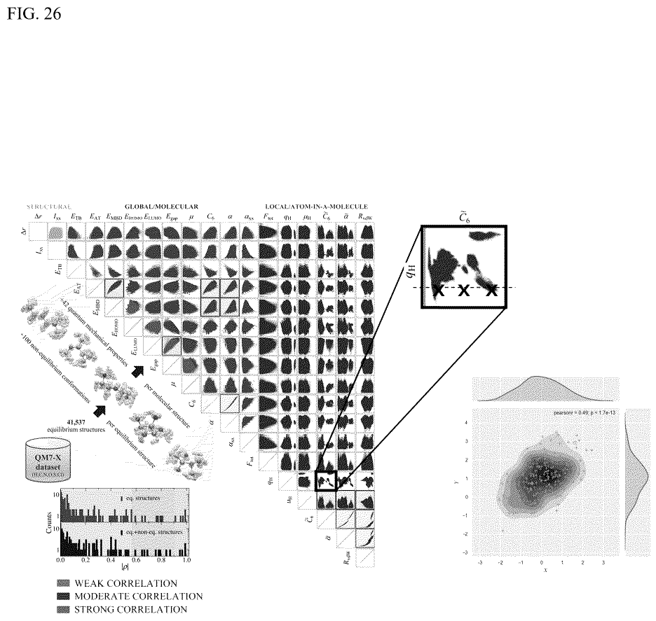

FIG. 26 illustrates examples of output data based on a density estimation algorithm according to one embodiment of the present disclosure.

Referring to FIG. 26, in an embodiment, the computing system 1000 may acquire an estimated density value (hereinafter, “first input data density”) for the physical property input information in linkage with the generation difficulty evaluation module (GDM) trained as described above.

In more detail, in an embodiment, the computing system 1000 may input the physical property input information into the generation difficulty evaluation module (GDM).

Then, the generation difficulty evaluation module (GDM) may estimate the density value for the input physical property input information based on previously trained information and provide the density value to the computing system 1000.

Thus, in an embodiment, the computing system 1000 may acquire the density value for the physical property input information (that is, the first input data density) from the generation difficulty evaluation module (GDM).

Additionally, in an embodiment, the computing system 1000 may calculate the first validity index (VI 1) described above based on the acquired first input data density.

As an example, the computing system 1000 may calculate the first validity index (VI 1) in proportion to the density of first input data.

That is, in an embodiment, the computing system 1000 may calculate the first validity index (VI 1) such that the higher the first input data density, the higher the first validity index (VI 1), and the lower the first input data density, the lower the first validity index (VI 1).

In another embodiment, the computing system 1000 may set the first validity index (VI 1) by comparing the first input data density with a predetermined reference value.

For example, the computing system 1000 may set the first validity index (VI 1) to “high” when the first input data density is equal to or more than a predetermined reference value, and may set the first validity index (VI 1) to “low” when the first input data density is less than the predetermined reference value.

In addition, in an embodiment, the computing system 1000 may calculate 2) a second validity index (VI 2), which is a low-dimensional latent variable-based validity index, based on the density estimation algorithm.

In detail, in an embodiment, the computing system 1000 may acquire the low-dimensional latent variable according to acquired physical property input information.

Here, the low-dimensional latent variable according to an embodiment may mean data transformed by projecting the given input data into a low-dimensional Gaussian space. In the embodiment, such a low-dimensional latent variable may be expressed as each point existing in the low-dimensional Gaussian space.

In detail, in an embodiment, the computing system 1000 may acquire the low-dimensional latent variable according to the physical property input information by transforming the physical property input information into a low-dimensional Gaussian space by linking with a sampler module (SPM) to be expressed in L (1 L<N, T) dimensions.

In addition, in an embodiment, the computing system 1000 may acquire an estimated density value (hereinafter, second input data density) for the low-dimensional latent variable acquired as described above in linkage with the generation difficulty evaluation module (GDM).

In detail, in an embodiment, the computing system 1000 may input a low-dimensional latent variable into the generation difficulty evaluation module (GDM).

Then, the generation difficulty evaluation module (GDM) may estimate the density value for the input low-dimensional latent variable based on previously trained information and provide the estimated density value to the computing system 1000.

Thus, in an embodiment, the computing system 1000 may acquire the density value (that is, a second input data density) for the low-dimensional latent variable from the generation difficulty evaluation module (GDM).

Additionally, in an embodiment, the computing system 1000 may calculate the second validity index (VI 2) described above based on the acquired second input data density.

As an example, the computing system 1000 may calculate the second validity index (VI 2) in proportion to the second input data density.

That is, in an embodiment, the computing system 1000 may calculate the second validity index (VI 2) such that the higher the second input data density, the higher the second validity index (VI 2), and the lower the second input data density, the lower the second validity index (VI 2).

In another embodiment, the computing system 1000 may set the second validity index (VI 2) by comparing the second input data density with a predetermined reference value.

For example, the computing system 1000 may set the second validity index (VI 2) to “high” when the second input data density is equal to or more than a predetermined reference value, and may set the second validity index (VI 2) to “low” when the second input data density is less than the predetermined reference value.

In addition, in an embodiment, the computing system 1000 may calculate 3) a third validity index (VI 3), which is a high-dimensional latent variable-based validity index, based on the density estimation algorithm.

For instance, the high-dimensional latent variable according to an embodiment may mean data that is sampled from the given input data in a low-dimensional Gaussian space and then restored to a high-dimensional space through an optimization process.

In an embodiment, these high-dimensional latent variables may form physically plausible physical property combinations that satisfy N physical property values desired by the user (that is, target physical property values).

In detail, the computing system 1000 according to one embodiment of the present disclosure may acquire a sampling latent variable based on the low-dimensional latent variable acquired as described above.

Here, the sampling latent variable according to the embodiment may mean the data sampled based on the low-dimensional latent variable existing in the low-dimensional Gaussian space.

In the embodiment, these sampling latent variables may express various combinations of physical properties based on each point existing in the low-dimensional Gaussian space.

For example, the computing system 1000 may perform data sampling in the low-dimensional Gaussian space using low-dimensional latent variables such as mean and/or variance.

Accordingly, the computing system 1000 may acquire the sampling latent variable based on the low-dimensional latent variable existing in a low-dimensional Gaussian space.

Additionally, in an embodiment, the computing system 1000 may acquire an optimized latent variable based on the acquired sampled latent variable.

Here, the optimized latent variable according to an embodiment may mean a sampling latent variable optimized through a genetic algorithm (GA).

In an embodiment, the optimized latent variable may satisfy target physical property values according to user needs while including various combinations of physical properties.

For example, the genetic algorithm (GA) may mean an optimization algorithm that imitates the principles of natural selection and heredity to find the optimal solution. This genetic algorithm may be an algorithm that starts from an initial population, selects individuals based on the calculated fitness calculated, and gradually finds a better solution through the process of crossbreeding and mutation generation based on the selected individuals.

In detail, in an embodiment, the computing system 1000 may perform GA optimization based on the acquired sampled latent variables.

In more detail, in an embodiment, the computing system 1000 may optimize the sampling latent variable in a direction that satisfies the target physical property value described above using the genetic algorithm as described above.

In other words, the computing system 1000 may optimize N physical properties among the T-dimensional property combinations included in the output data (in an embodiment, molecular structural formula data, or the like) of the multi-tasking learning model (MtLM) to achieve target values according to user input by manipulating the sampling latent variables of a low-dimensional Gaussian space through the genetic algorithm.

Thus, in an embodiment, the computing system 1000 may acquire latent variables of a GA-optimized low-dimensional Gaussian space (that is, optimized latent variables).

Additionally, in an embodiment, the computing system 1000 may acquire the high-dimensional latent variable based on the acquired optimized latent variable.

Here, the high-dimensional latent variable according to an embodiment may mean data in which the optimized latent variable is restored back to the high-dimensional space.

In an embodiment, the high-dimensional latent variable may form physically plausible physical property combinations that satisfy N physical property values desired by the user (that is, target physical property values).

In detail, in an embodiment, the computing system 1000 may, in linkage with the sampler module (SPM) described above, project an optimized latent variable in a low-dimensional (that is, L-dimensional) Gaussian space into a high-dimensional (that is, T-dimensional) space and transform the optimized latent variable so that the optimized latent variable is expressed in T dimensions.

In other words, the computing system 1000 may project an L-dimensional Gaussian latent variable into a T-dimensional physical property set supported by the multi-tasking learning model (MtLM).

Thus, the computing system 1000 may acquire the high-dimensional latent variable, which is data that projects the optimized latent variable of the low-dimensional Gaussian space into the T-dimensional space supported by the multi-tasking learning model (MtLM).

In more detail, in an embodiment, the computing system 1000 may input the optimized latent variable into a predetermined decoding network.

In this way, the decoding network may restore the input optimized latent variable into a high-dimensional (here, T-dimensional) space.

In this case, the decoding network may restore the optimized latent variable to the T-dimensional space while maintaining the correlation between the physical properties.

Moreover, the decoding network may provide the optimized latent variable (that is, the high-dimensional latent variable) restored to the high-dimensional (here, T-dimensional) space to the computing system 1000.

Thus, in an embodiment, the computing system 1000 may acquire data (in an embodiment, a high-dimensional latent variable) by projecting data in the T-dimensional space according to T different types of physical properties into an L (1≤L<N, T)-dimensional space, sampling the data, and then restoring the data back into the T-dimensional space.

In addition, in an embodiment, the computing system 1000 may acquire an estimated density value (hereinafter, third input data density) for the high-dimensional latent variable acquired as described above in linkage with the generation difficulty evaluation module (GDM).

In detail, in an embodiment, the computing system 1000 may input the high-dimensional latent variable into the generation difficulty evaluation module (GDM).

Then, the generation difficulty evaluation module (GDM) may estimate the density value for the input high-dimensional latent variable based on previously trained information and provide the estimated density value to the computing system 1000.

Thus, in an embodiment, the computing system 1000 may acquire the density value (that is, third input data density) for the high-dimensional latent variable from the generation difficulty evaluation module (GDM).

Additionally, in an embodiment, the computing system 1000 may calculate the third validity index (VI 3) described above based on the acquired third input data density.

As an example, the computing system 1000 may calculate the third validity index (VI 3) in proportion to the third input data density.

That is, in an embodiment, the computing system 1000 may calculate the third validity index (VI 3) such that the higher the third input data density, the higher the third validity index (VI 3), and the lower the third input data density, the lower the third validity index (VI 3).

In another embodiment, the computing system 1000 may set a first validity index (VI 1) by comparing the density of third input data with a predetermined reference value.

For example, the computing system 1000 may set the third validity index (VI 3) to “high” when the third input data density is equal to or more than a predetermined reference value, and may set the third validity index (VI 3) to “low” when the third input data density is less than the predetermined reference value.

As described above, in an embodiment, the computing system 1000 may analyze the density of given data and determine the generation difficulty of the molecular structural formula generated based on the data.

Thus, the computing system 1000 may provide a determination on the probability of generation of the molecular structure formula according to the given data (here, physical property input information) based on rational determination based on the objective fact that there is a correlation between the density of input physical properties (that is, low-dimensional data) and the density of reconstructed physical properties (that is, high-dimensional data), and that the lower the data density, the higher the difficulty of generating output data (in an embodiment, molecular structure formula data, or the like).

In this case, in an embodiment, the computing system 1000 can further improve the accuracy and reliability of the validity index calculated by analyzing the density of the given data in various dimensions.

In this case, according to an embodiment, the computing system 1000 may further utilize a marginal probability distribution estimation algorithm to calculate the third validity index (VI 3).

Here, for reference, the marginal probability distribution algorithm is an algorithm that calculates the probability distribution of a specific variable or set of variables in a multidimensional probability distribution, and may be an algorithm that calculates the marginal probability of a specific variable and integrates and analyzes the influence of the remaining variables.

In detail, in an embodiment, the computing system 1000 may calculate the marginal probabilities based on the high-dimensional latent variable using the marginal probability distribution estimation algorithm.

As an example, the computing system 1000 may calculate the marginal probability by performing integration for the remaining (T−1) variables when evaluating the possibility of the first physical property in T-dimensional (for example, 45-dimensional) latent variables.

Moreover, the computing system 1000 may calculate the third validity index (VI 3) described above by reflecting the calculated peripheral probability.

That is, according to an embodiment, the computing system 1000 may analyze a joint distribution based on a specific variable in the high-dimensional data (here, high-dimensional latent variable) through the peripheral probability distribution estimation algorithm, and calculate the third validity index (VI 3) by reflecting the joint distribution.

Through this, the computing system 1000 can more efficiently implement data processing for high-dimensional data for which it is difficult to evaluate the joint distribution of all variables, and can easily calculate the validity index (here, the third validity index (VI 3)) accordingly.

Meanwhile, according to an embodiment, the computing system 1000 may evaluate the performance of the generation difficulty evaluation module (GDM) based on the second input data density (that is, the estimated density value for the low-dimensional latent variable) and the third input data density (that is, the estimated density value for the high-dimensional latent variable).

In detail, in an embodiment, the computing system 1000 may determine mutual similarity by comparing the second input data density (that is, low-dimensional latent variable density) and the third input data density (that is, high-dimensional latent variable density).

In more detail, in an embodiment, the computing system 1000 may identify an area having a low density (hereinafter, a low-density area) and an area having a high density (hereinafter, a high-density area) in each of the second input data density and the third input data density.

Moreover, the computing system 1000 may compare the data distribution according to the second input data density and the data distribution according to the third input data density in each of the identified low-density area and high-density area.

Through this, in an embodiment, the computing system 1000 may determine the mutual similarity between the second input data density and the third input data density.

Additionally, in an embodiment, the computing system 1000 may determine a correlation between the second input data density and the third input data density in proportion to the determined similarity.

That is, the computing system 1000 may determine that the higher the determined similarity, the higher the correlation between the data distribution according to the second input data density and the data distribution according to the third input data density.

Through this, in an embodiment, the computing system 1000 may verify whether the second input data density (that is, low-dimensional latent variable density) is effective as a predictive indicator of the third input data density (that is, high-dimensional latent variable density), and at the same time may evaluate the estimation performance of the generation difficulty evaluation module (GDM).

In an embodiment, the computing system 1000 may train the generation difficulty evaluation module (GDM) to execute the density value estimation process to increase the correlation described above (that is, so that the second input data density and the third input data density become close to each other).

Therefore, the computing system 1000 may further improve the accuracy and reliability of the generation difficulty evaluation module (GDM).

Meanwhile, according to an embodiment, the computing system 1000 may also calculate a validity index (hereinafter, an “intermediate-dimensional validity index”) based on a latent variable (hereinafter, an “intermediate-dimensional latent variable”) in an M (L<M<T)-dimensional space existing between an L-dimensional low-dimensional Gaussian space and a T-dimensional high-dimensional space based on the density estimation algorithm.

In detail, in an embodiment, the computing system 1000 may acquire the intermediate-dimensional latent variable, which is data that restores the optimized latent variable based on the low-dimensional Gaussian space as described above into the predetermined M dimension.

In this case, the specific method by which the computing system 1000 according to an embodiment restores the L-dimensional latent variable to the M-dimensional latent variable is omitted by applying the description of the above-described method of restoring the L-dimensional latent variable to the T-dimensional latent variable.

In addition, in an embodiment, the computing system 1000 may acquire an estimated density value (hereinafter, “intermediate-dimensional input data density”) for the intermediate-dimensional latent variable acquired as described above in linkage with the generation difficulty evaluation module (GDM).

In more detail, in an embodiment, the computing system 1000 may input the intermediate-dimensional latent variable into the generation difficulty evaluation module (GDM).

Then, the generation difficulty evaluation module (GDM) may estimate the density value for the input intermediate-dimensional latent variable based on the previously trained information and provide the estimated density value to the computing system 1000.

Thus, in an embodiment, the computing system 1000 may acquire the density value for the intermediate-dimensional latent variable (that is, intermediate-dimensional input data density) from the generation difficulty evaluation module (GDM).

Additionally, in an embodiment, the computing system 1000 may calculate the above-described intermediate-dimensional validity index based on the acquired intermediate-dimensional input data density.

As an example, the computing system 1000 may calculate the intermediate-dimensional validity index in proportion to the intermediate-dimensional input data density.

That is, in an embodiment, the computing system 1000 may calculate the intermediate-dimensional validity index so that the intermediate-dimensional validity index increases as the intermediate-dimensional input data density increases, and the intermediate-dimensional validity index decreases as the intermediate-dimensional input data density decreases.

In another embodiment, the computing system 1000 may set the intermediate-dimensional validity index by comparing the intermediate-dimensional input data density with a predetermined reference value.

For example, the computing system 1000 may set the intermediate dimension validity index to “high” when the intermediate dimension input data density is equal to or more than a predetermined reference value, and may set the intermediate dimension validity index to “low” when the intermediate dimension input data density is less than the predetermined reference value.

Through this, in an embodiment, the computing system 1000 can easily avoid reduction in the accuracy of density estimation caused by problems such as data sparsity in the low-dimensional space and/or the high-dimensional space.

Returning to FIG. 24, as an example, the computing system 1000 may calculate 2) a validity index based on an anomaly detection algorithm.

In detail, in an embodiment, the computing system 1000 may acquire a fourth validity index (VI 4), which is a validity index calculated using a predetermined anomaly detection algorithm.

For example, the anomaly detection algorithm may be an algorithm that detects anomalies that differ from normal patterns in a predetermined data set.

In an embodiment, the computing system 1000 may detect an anomaly based on at least one of the first to third input data densities described above by utilizing the anomaly detection algorithm described above, and calculate the fourth validity index (VI 4) described above according to the number of detected anomalies.

In this case, the anomaly detected from at least one of the first to third input data densities may mean a data point (that is, anomaly) that is spaced apart from most of the data points (that is, data points of a normal pattern) among a plurality of data points included in a specific input data density.

In other words, the anomaly indicates the presence of data points that are separated from other data points, which may imply low density between data points.

Therefore, in an embodiment, the computing system 1000 may determine that the data density is lower as the number of anomalies increases, and accordingly, may set the validity index low (that is, the generation difficulty high).

In more detail, in an embodiment, the computing system 1000 may perform anomaly detection based on at least one of the first to third input data densities using a predetermined anomaly detection algorithm (for example, K-Nearest Neighbors (KNN) Density Estimation and/or Local Outlier Factor (LOF)).

Through this, the computing system 1000 may detect the anomaly based on at least one of the first to third input data densities.

In an embodiment, the computing system 1000 may detect at least one data point (that is, a data point in a low-density area) whose average distance from other data points is equal or more than a predetermined reference value from at least one of the first to third input data densities.

Moreover, the computing system 1000 may identify at least one detected data point as the anomaly.

Additionally, in an embodiment, the computing system 1000 may count the number of identified anomalies.

Additionally, in an embodiment, the computing system 1000 may calculate a fourth validity index (VI 4) in inverse proportion to the number of counted anomalies.

That is, the computing system 1000 may calculate the fourth validity index (VI 4) such that the fourth validity index (VI 4) decreases as the number of anomalies (that is, the number of data points existing in the low-density area) increases, and the fourth validity index (VI 4) increases as the number of anomalies decreases.

In another embodiment, the computing system 1000 can set the fourth validity index (VI 4) by comparing the number of anomalies with a predetermined reference value.

For example, the computing system 1000 may set the fourth validity index (VI 4) to “high” when the number of anomalies is equal to or more than a predetermined reference value, and may set the fourth validity index (VI 4) to “low” when the number of anomalies is less than the predetermined reference value.

In this way, in an embodiment, the computing system 1000 may detect the anomaly in given data through anomaly detection, and calculate the validity index by determining the density of the corresponding data based on the number of detected anomalies. In this case, in an embodiment, the computing system 1000 may contribute to correction of abnormal distribution of data and increase of the prediction accuracy of the model by utilizing anomaly detection.

In addition, referring to FIG. 24, as an example, the computing system 1000 may calculate 3) the validity index based on the similarity determination algorithm.

In detail, in an embodiment, the computing system 1000 may acquire a fifth validity index (VI 5), which is a validity index calculated using a predetermined similarity determination algorithm.

For example, the similarity determination algorithm may be an algorithm that measures the similarity between predetermined data and expresses the similarity numerically.

In an embodiment, the computing system 1000 may measure the similarity between output data (that is, molecular structure formula data, or the like) according to an embodiment of the present disclosure and actual data (that is, actual molecular structure formula data, or the like) through the similarity determination algorithm as described above, and acquire data (hereinafter, similarity value) that quantifies the similarity.

In this case, the similarity value according to an embodiment may be an indicator of how similar the output data based on the given data (here, the physical property input information) is to the actual data.

Therefore, in an embodiment, the computing system 1000 may determine that the higher the similarity value, the higher the data density, and accordingly set the validity index high (that is, decrease the generation difficulty).

In more detail, in an embodiment, the computing system 1000 may generate output data according to the high-dimensional latent variables acquired as described above.

As an example, the computing system 1000 may perform a deep learning prediction process using the acquired high-dimensional latent variables as target characteristics.

Here, the target characteristic according to an embodiment may mean an optimal solution that the output data according to the prediction process of a predetermined deep learning model is trying to achieve.

That is, in an embodiment, the target characteristic may mean an optimal solution that the output data (in an embodiment, molecular structural formula data, or the like) according to the prediction process of the multi-tasking learning model (MtLM) is intended to achieve.

In detail, in an embodiment, the computing system 1000 may provide the high-dimensional latent variable acquired according to the process described above to the multi-tasking learning model (MtLM).

In this way, the multi-tasking learning model (MtLM) may execute a prediction process using the provided high-dimensional latent variable (T-dimensional perturbance) as the target characteristic.

In this case, in other words, the multi-tasking learning model (MtLM) according to an embodiment may perform a prediction process using, as input data, the characteristic value (in an embodiment, physical property input information) for each of N (1<=N<T) physical properties (that is, N-dimensional physical properties), and as output data, a predetermined molecular structural formula data that satisfies the N input physical property values.

Here, the molecular structural formula data is data that expresses and stores the structure, such as the composition and bonding method of the molecule, and in an embodiment, may be data that includes the molecular structural formula that satisfies N physical property values according to the physical property input information and expresses a physically valid physical property combination.

In the above process, the multi-tasking learning model (MtLM) may perform the prediction process to satisfy the given target characteristics.

In other words, the multi-tasking learning model (MtLM) may perform a prediction process to generate the molecular structure formula by reflecting the physical properties input by the user and plausibly combining the characteristics of the remaining physical properties not input by the user.

In this case, the multi-tasking learning model (MtLM) in an embodiment may execute the prediction process based on the geometric alignment in the above-described integrated latent space (M).

Thus, in an embodiment, the computing system 1000 may perform the deep learning prediction process using the high-dimensional latent variables as target characteristics through linkage with the multi-tasking learning model (MtLM).

Additionally, in an embodiment, the computing system 1000 may generate the output data according to the performed deep learning prediction process.

In detail, in an embodiment, the multi-tasking learning model (MtLM) performs a prediction process using the high-dimensional latent variables as target physical properties as described above, thereby generating the molecular structural data that reflects the characteristics of the physical properties input by the user and reasonably combines the characteristics of the remaining physical properties not input by the user.

Moreover, the multi-tasking learning model (MtLM) may provide the generated molecular structure data to the computing system 1000.

Accordingly, in an embodiment, the computing system 1000 performs a prediction process using the high-dimensional latent variable as the target physical property, thereby generating the molecular structural formula data that reflects the characteristics of the physical properties input by the user while reasonably combining the characteristics of the remaining physical properties not input by the user.

That is, in an embodiment, the computing system 1000 can generate molecular structural formula data designed in a form suitable for forming an actual molecular structure while retaining the characteristics for each physical property desired by the user.

In an embodiment, the computing system 1000 may acquire a similarity value according to the generated output data (that is, molecular structural formula data, or the like) using a predetermined similarity determination algorithm (for example, generative adversarial networks (GANs), Euclidean distance, cosine similarity, Jaccard similarity, Pearson correlation coefficient, and/or cross-entropy, or the like).

In the following examples, the similarity determination algorithm is described based on, but not limited to, the generative adversarial networks (GANs).

For instance, the generative adversarial networks may include a discriminator model that determines whether the input data is actual data that has been previously trained or newly generated data and outputs a probability score for it.

In this case, in order for the discriminant model to operate as above, the generative adversarial network may be pre-trained based on a training data set containing the plurality of molecular structural formula data (that is, actual data).

In detail, in an embodiment, the computing system 1000 may input the generated output data into the generative adversarial network.

Then, the generative adversarial network may output the probability score for the input output data using the discriminant model included in the generative adversarial network.

That is, the generative adversarial network may output a probability score, which is data that converts the probability that the output data (in an embodiment, molecular structure data, or the like) generated according to an embodiment of the present disclosure is actual molecular structure data (that is, label) that has been pre-trained into a numerical value.

Moreover, the generative adversarial network may provide the output probability score to the computing system 1000.

Thus, in an embodiment, the computing system 1000 may acquire a probability score indicating the probability that the output data is real data (that is, the degree to which the output data is similar to the real data) through the generative adversarial network.

Additionally, in an embodiment, the computing system 1000 can calculate the similarity value based on the probability score acquired as described above.

Additionally, in an embodiment, the computing system 1000 may calculate the fifth validity index (VI 5) in proportion to the calculated similarity value.

That is, in an embodiment, the computing system 1000 may evaluate that the combination of physical properties according to the output data is more similar to the combination of physical properties according to the actual data as the similarity value (probability score) is higher, and may calculate the fifth validity index (VI 5) reflecting this.

In an embodiment, the computing system 1000 may calculate the fifth validity index (VI 5) such that the higher the similarity value, the higher the fifth validity index (VI 5), and the lower the similarity value, the lower the fifth validity index (VI 5).

In another embodiment, the computing system 1000 may set the fifth validity index (VI 5) by comparing the similarity value with a predetermined reference value.

For example, the computing system 1000 may set the fifth validity index (VI 5) to “high” when the similarity value is equal to or more than a predetermined reference value, and may set the fifth validity index (VI 5) to “low” when the similarity value is less than the predetermined reference value.

In this way, in an embodiment, the computing system 1000 can calculate the validity index (that is, actual generation possibility) for the given physical property input information by determining the similarity between the output data according to the given physical property input information and the actual data.

Returning to FIG. 25, in the embodiment described above, the computing system 1000 may use various deep learning algorithms to calculate first to fifth validity indexes (VI 1, VI 2, VI 3, VI 4, and VI 5) indicating the validity (that is, generation difficulty, generation probability, and/or feasibility) of the physical property input information.

In other words, the computing system 1000 may analyze the validity by determining how high the probability of success is in the molecule generation process according to the physical property values input by the user and how similar the physical property values input by the user are to actual data, and may calculate the validity index that quantitatively expresses the validity.

In this way, in an embodiment, the computing system 1000 may calculate and provide the validity index that quantitatively expresses the difficulty in generation of molecules according to the physical property values input by the user.

Through this, the computing system 1000 may easily provide a guide indicator that supports physically or scientifically possible molecule generation while following the physical property values input by the user, based on objective evidence.

According to an embodiment, the computing system 1000 can further improve the accuracy and reliability by determining the validity indicator using various deep learning algorithms.

In addition, at step S305, the computing system 1000 according to one embodiment of the present disclosure may provide a physical property guide based on the calculated validity index.

Here, the physical property guide according to an embodiment may mean data that presents physical properties and/or physical property values that enhance the physical or scientific validity of the molecular structural formula (that is, physical property combination) generated according to predetermined physical property input information.

In other words, the physical property guide according to an embodiment may mean data that evaluates whether the molecular structural formula following the physical property value input by the user is physically or scientifically valid, and then guides the direction of change or modification for a specific physical property and/or physical property value to improve the validity based on the evaluation result.

According to an embodiment, the physical property guide may include analysis information (for example, analysis data according to the first to fifth validity indexes (VI 1, VI 2, VI 3, VI 4, and VI 5)) indicating the cause of derivation of the proposed change or modification direction.

In addition, the physical property guide according to an embodiment may mean data that suggests a training method that enhances the physical or scientific validity of the molecular structural formula (that is, a physical property combination) generated according to predetermined physical property input information.

For example, the physical property guide may include data requesting additional data for areas of low validity or suggesting ways to supplement the training data.

In detail, in an embodiment, the computing system 1000 can generate the above-described physical property guide based on the first to fifth validity indexes VI 1, VI 2, VI 3, VI 4, and VI 5 calculated as above.

In more detail, referring further to FIG. 26, in an embodiment, the computing system 1000 may acquire a composite the validity index (CVI) based on the first to fifth validity indexes (VI 1, VI 2, VI 3, VI 4, and VI 5).

Here, the composite validity index (CVI) according to an embodiment may mean data that integrates or compiles at least some of the first to fifth validity indexes (VI 1, VI 2, VI 3, VI 4, and VI 5) into one according to a predetermined method.

That is, in an embodiment, the computing system 1000 may acquire the composite validity index (CVI) by integrating the first to fifth validity indexes (VI 1, VI 2, VI 3, VI 4, and VI 5) into one data based on a predetermined method (for example, calculating an average value, or the like).

In this case, according to an embodiment, the computing system 1000 may preset the importance or weight for each of the first to fifth validity indexes (VI 1, VI 2, VI 3, VI 4, and VI 5) according to user settings.

Moreover, the computing system 1000 may acquire the composite validity index (CVI) by integrating the first to fifth validity indexes (VI 1, VI 2, VI 3, VI 4, and VI 5) into one according to a predetermined method by reflecting the preset importance or weight.

Additionally, in an embodiment, the computing system 1000 may generate the above-described physical property guide based on the acquired composite validity index (CVI).

In detail, in an embodiment, the computing system 1000 may generate the physical property recommendation guide and/or the physical property value recommendation guide based on the composite validity index (CVI).

Here, the physical property recommendation guide according to an embodiment may mean a physical property guide that suggests a physical property change that increases the composite validity index (CVI) based on predetermined physical property input information.

That is, in an embodiment, the physical property recommendation guide may be data suggesting physical properties to be removed, replaced, and/or added among physical properties associated with the predetermined physical property input information to increase the composite validity index (CVI).

In addition, the physical property value recommendation guide according to an embodiment may mean a physical property guide that suggests a change in the physical property value (here, the value includes a range) that increases the composite validity index (CVI) based on the predetermined physical property input information.

That is, in an embodiment, the physical property value recommendation guide may be data suggesting the physical property value that is updated to increase the composite validity index (CVI) among the characteristic values (that is, physical property values) of the physical property associated with the given physical property input information.

In the above, the physical property recommendation guide and the physical property value recommendation guide have been separately explained for explanation of one embodiment, but various embodiments are possible, such as at least some of the above-described configurations may be organically combined and operated depending on an embodiment.

As an example, the physical property recommendation guide and the physical property value recommendation guide may be organically combined to implement the physical property guide that presents a physical property added to increase the composite validity index (CVI) among physical properties associated with a given physical property input information and the characteristic value (that is, physical property value) of the added physical property.

In an embodiment, the computing system 1000 may generate the physical property recommendation guide and/or the physical property value recommendation guide that suggests changes to predetermined physical properties and/or physical property values to increase the composite validity index (CVI) (that is, to decrease the generation difficulty).

Thus, in an embodiment, the computing system 1000 may generate the physical property guide that presents the physical properties and/or physical property values that enhance the physical or scientific validity of the molecular structural formula (that is, the physical property combination) generated according to physical property input information input by the user.

For example, the computing system 1000 may generate a first physical property guide including data such as:

### [First Physical Property Guide: Removing and Replacing Specific Physical Property Value]

Input physical property value: physical property A: 35, physical property B: 25, physical property C: 80
Evaluation results: as a result of the isolation forest, the physical property C value of 80 was found to be abnormally high, indicating that the difficulty in generation of molecules is very high.
Suggested modification direction: it is suggested to use physical property D, which is highly related to physical property C, instead of physical property C. It is suggested to set the value range of the physical property D from 40 to 50.
Modified physical property values: physical property A: 35, physical property B: 25, physical property D: 45 (replace physical property C, choose from the suggested range)

As another example, the computing system 1000 may generate a second physical property guide including data such as:

### [Second Physical Property Guide: Adjusting Specific Physical Property Value Range]

Input physical property values: physical property A: 30, physical property B: 15, physical property C: 45
Evaluation results: through KDE and GAN discriminator output, it is determined that the density of physical property A is very low within the input range, which increasing the difficulty in generation of molecules. It is confirmed that molecule generation is difficult in areas with low density.
Suggested modification direction: it is suggested to adjust the value of physical property A from 20 to 25. In this range, the data density is high, so the difficulty in generation of molecules is expected to decrease.
Modified physical property values: physical property A: 22 (select from suggested range), physical property B: 15, physical property C: 45

As another example, the computing system 1000 may generate a third physical property guide that includes data such as:

### [Third Physical Property Guide: Simultaneous Adjustment of Multiple Physical Property Value]

Input physical property value: physical property A: 10, physical property B: 50, physical property C: 70
Evaluation results: according to the LOF and Autoencoder results, the combination of physical properties B and C is abnormal, and the physical properties B and C have low data density when they are together, which increase the difficulty in generation of molecules.
Suggested modification direction: considering the correlation between physical properties B and C, it is suggested to adjust the value of physical property B from 40 to 45 and the value of physical property C from 60 to 65. In this range, the correlation between the two physical property values is expected to increase further, thereby decreasing the difficulty in generation of molecules.
Modified physical property values: physical property A: 10, physical property B: 42 (select from suggested range), physical property C: 63 (select from suggested range)

In this way, in an embodiment, the computing system 1000 may verify the validity of the molecular structural formula according to the physical property values input by the user, and based on this, specifically suggest the direction for changing the physical property and/or the physical property values that increases the success probability of molecule generation while guaranteeing physical/scientific validity.

Thus, the computing system 1000 can support the multi-tasking model according to an embodiment to generate physically possible molecules, identify abnormal input values and prevent errors resulting therefrom, thereby improving the success rate of molecule generation of the multi-tasking model, and continuously improving its performance.

In addition, the computing system 1000 can enhance user experience and satisfaction by providing users with clear modification directions for generating molecules that ensure physical/scientific validity.

Meanwhile, according to an embodiment, the computing system 1000 may generate a learning recommendation guide based on the composite validity index (CVI).

Here, the learning recommendation guide according to an embodiment may mean the physical property guide that suggests a training method to increase the composite validity index (CVI) based on the predetermined physical property input information.

That is, the computing system 1000 may generate the physical property guide including the learning recommendation guide described above.

For example, the computing system 1000 may generate a fourth physical property guide including data such as:

### [Fourth Physical Property Guide: Insufficient Data for Specific Physical Property Value]

Input physical property value: physical property A: 10, physical Property B: 35, physical Property C: 60
Evaluation results: through KDE and LOF, it is confirmed that the data density of the physical property C value 60 is very low and the model does not work well at that value. The prediction performance of the model is poor due to insufficient training data for the physical property C.
Suggested modification direction: it is suggested that the model learning is supplemented by collecting additional data for the physical property C values between 55 and 65. When collecting new data, it is recommended to include various combinations by considering values for the physical property A and physical property B.
Collect additional data: additionally collect new data points for the physical property A: 10, physical property B: 35, and physical property C: 55 to 65.

As another example, the computing system 1000 may generate a fifth physical property guide including data such as:

### [Fourth Physical Property Guide: High-Dimensional Correlation Lack]

Input physical property value: physical property A: 20, physical property B: 50, physical property C: 70
Evaluation results: Through the GAN Discriminator output, it is confirmed that the combination of physical properties B and C is different from the actual data, and that the model has not sufficiently trained the combination. There is insufficient training data on the correlation between the physical properties B and C.
Suggested modification direction: it is suggested that the learning is supplemented by collecting additional data for the physical property B values between 45 and 55 and physical property C values between 65 and 75. Moreover, it is suggested to adjust the physical property A values to a wider range to increase data diversity.
Collect additional data: additionally collect new data points for physical property A: various values, physical property B: 45 to 55, and physical property C: 65 to 75.

As another example, the computing system 1000 can generate a sixth physical property guide including data such as:

### [Sixth Physical Property Guide: Model Performance Degradation in Specific Domain]

Input property value: physical property A: 25, physical property B: 30, physical property C: 50 Evaluation result: Through the isolation forest results, it is confirmed that the combination of physical property A value 25 and physical property B value 30 is abnormal, and the performance of the model deteriorates with this combination. The prediction performance of the model deteriorates due to insufficient training data for this combination.
Suggested modification direction: it is suggested that additional data is collected for physical property A values between 20 and 30 and physical property B values between 25 and 35 to supplement the model learning. Moreover, it is suggested to adjust the physical property C values to a wider range to increase data diversity.
Collect additional data: additionally collect new data points for physical property A: 20 to 30, physical property B: 25 to 35, and physical property C: various values.

In this way, in an embodiment, the computing system 1000 can directly improve the performance of the multi-tasking model by providing specific guidance on additional learning required for the physical property values input by the user, and as a result, can also significantly improve the quality of the model's output data (that is, molecular structural formula data, or the like).

In this case, according to an embodiment, the computing system 1000 may generate and provide the physical property guide as described above when the composite validity index (CVI) described above is lower than a predetermined reference value (that is, when the difficulty in generation of molecules according to the physical property values input by the user is equal to or more than a predetermined reference value).

Accordingly, the computing system 1000 can minimize the load resulting from indiscriminate data processing.

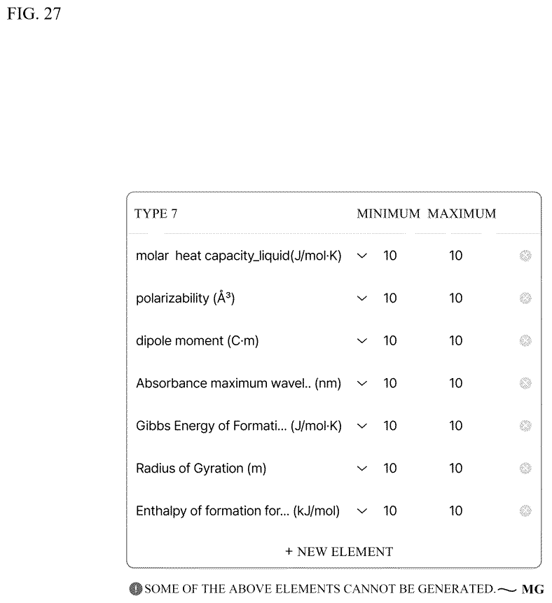

FIG. 27 illustrates an example of visualizing a physical property guide according to one embodiment of the present disclosure.

Referring to FIG. 27, in an embodiment, the computing system 1000 may provide a visualization of the physical property guide (MG) generated as described above in a predetermined manner.

As an example, the computing system 1000 may provide a visualized physical property guide (MG) based on a predetermined graphic image that displays the physical property guide (MG) and corresponding physical property input information and/or output data (that is, molecular structural formula data, or the like) by matching them with each other.

In another embodiment, the computing system 1000 may provide a visualization of the physical property guide (MG) based on a predetermined pop-up window that displays the physical property guide (MG).

In this way, the computing system 1000 may visually provide quantitative evaluation of the validity of the physical property values input by the user and/or guidance therefor using various user interfaces.

Thus, the computing system 1000 can effectively support the user side to understand and grasp the physical property guide (MG) more easily and intuitively.

At step S307, the computing system 1000 according to one embodiment of the present disclosure may acquire predetermined physical property change information.

Here, the physical property change information according to an embodiment may mean information that changes a predetermined physical property and/or physical property value according to user input.

In other words, the physical property change information may be information that specifies the physical property and/or physical property value that has changed according to user input.

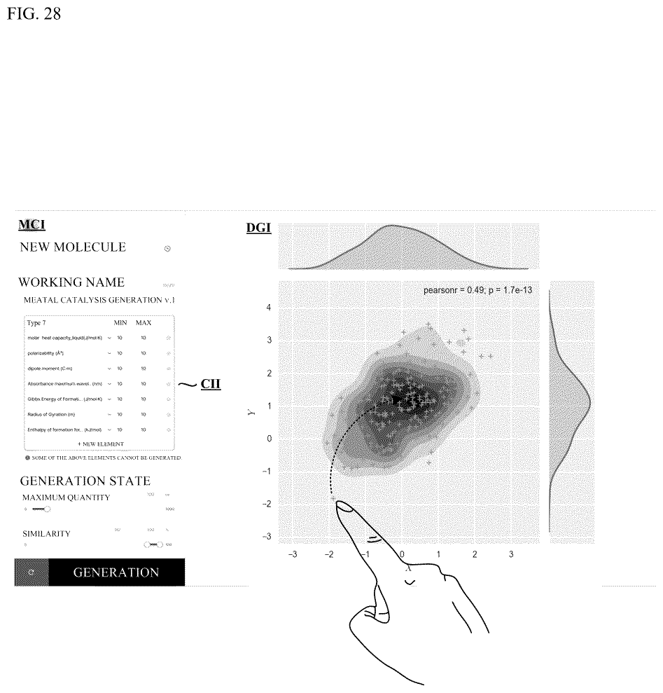

FIG. 28 illustrates an example for explaining a physical property change interface according to one embodiment of the present disclosure.

Referring to FIG. 28, in an embodiment, the computing system 1000 may provide a user interface (MCI: hereinafter, a physical property change interface) that can set the physical property change information in various ways.

Moreover, the computing system 1000 may acquire the above-described physical property change information based on user input based on the provided physical property change interface (MCI).

As an example, the computing system 1000 may provide the physical change interface (MCI) including an interface (DGI: hereinafter, a “data density graph interface”) that displays a density value (that is, data distribution) estimated through the generation difficulty evaluation module (GDM) in a graph format.

That is, the computing system 1000 may provide the physical property change interface (MCI) including the data density graph interface (DGI) that displays the distribution of each data point (that is, physical property value) related to physical property input information in a graph format through the generation difficulty evaluation module (GDM).

Additionally, in an embodiment, the computing system 1000 may acquire user input

for setting a specific physical property and/or physical property value based on a provided data density graph interface (DGI).

As an example, the computing system 1000 may acquire a user input (for example, a drag input, or the like) that changes the position of a data point (that is, a physical property value) on a graph (hereinafter, a “data density graph”) displayed through the data density graph interface (DGI).

For example, the computing system 1000 may acquire a user input to move a first data point (that is, a first physical property value) located in a low-density area on a data density graph to a high-density area on the data density graph.

As another example, the computing system 1000 may acquire a user input (that is, a user input that removes the first data point from the data density graph) that moves a first data point (that is, a first physical property value) located in a low-density area on the data density graph to an area other than the data density graph.

In this way, in an embodiment, the computing system 1000 may acquire the property change information according to user input for each data point (that is, physical property value) visualized in a graph image format.

That is, the computing system 1000 may acquire the physical property change information based on an interface that supports easier and more intuitive user interaction.

In another embodiment, the computing system 1000 may provide the physical property change interface (MCI) including an interface (CII: hereinafter an “change input interface”) for setting the physical property change information through predetermined text (for example, letters and/or numbers, or the like) and/or selection input, or the like.

Moreover, in an embodiment, the computing system 1000 may acquire user input to set a specific physical property and/or physical property values based on the provided change input interface (CII) based on predetermined text and/or selection input.

In an embodiment, the computing system 1000 may acquire a user's selection input (for example, a first physical property name selection input, or the like) and/or a text input (for example, a first physical property name text input, or the like) that sets the physical property to be removed, replaced, and/or added.

Additionally, the computing system 1000 according to an embodiment may acquire a user's selection input (for example, a first physical property value selection input, or the like) and/or a text input (for example, a first physical property value text input, or the like) for setting the physical property value to be changed or updated.

In this way, the computing system 1000 in an embodiment may acquire the specific physical property and/or physical property value with high accuracy based on a specific number or clear text through text and/or selection input.

Thus, the computing system 1000 may acquire the physical property change information that reflects the user's needs in more detail.

In the above, the embodiments have been described separately as described above for explanation of those specific embodiments, but various embodiments are possible, such as at least some of the embodiments described above may be organically combined and operated depending on an embodiment.

As an example, the computing system 1000 may organically combine the data density graph interface (DGI) and the change input interface (CII) to provide a method for adding the first physical property according to a user's text and/or a selection input, and acquiring the physical property change information for setting a physical property value of the first physical property according to a user's drag input for placing the first data point symbolizing the added first physical property on a data density graph.

In this way, in an embodiment, the computing system 1000 may acquire the physical property change information specifying the physical property and/or physical property value that the user wishes to set or change by utilizing various forms of user interfaces.

Through this, the computing system 1000 can improve the user convenience and satisfaction of using the multi-tasking learning model (MtLM), and also easily improve its usability.

At step S309, the computing system 1000 according to one embodiment of the present disclosure can provide an updated physical property guide (MG) based on the acquired physical property change information.

Here, the updated physical property guide (MG) according to an embodiment may mean a physical property guide (MG) according to physical property input information (hereinafter, “physical property update information”) reflecting the physical property change information described above.

That is, in an embodiment, the updated physical property guide (MG) may mean a physical property guide (MG) based on physical property update information reflecting newly set physical properties and/or physical property values according to an user input.

In detail, in an embodiment, the computing system 1000 may generate physical property update information, which is physical property input information reflecting the acquired physical property change information.

As an example, the computing system 1000 may generate the physical property update information by applying changes according to the physical property change information to existing physical property input information.

In another embodiment, the computing system 1000 may generate new physical property input information based on the physical property and/or physical property value according to the physical property change information to generate the physical property update information.

In addition, in an embodiment, the computing system 1000 may perform a process of calculating a validity index according to the generated physical property update information and generating and providing the physical property guide (MG) (that is, an updated physical property guide (MG)) based on the calculated validity index.

In this case, in an embodiment, the computing system 1000 may repeatedly perform the above-described process by generating the physical property update information whenever the physical property change information is acquired.

Thus, in an embodiment, the computing system 1000 may provide the updated physical property guide (MG) that analyzes the difficulty in generation of molecules based on predetermined the physical property and/or physical property value being updated through the user input and provides guidance toward increasing its validity.

Accordingly, the computing system 1000 can effectively improve the user experience of using the multi-tasking model guide provision service by allowing the user to easily understand and correct the validity of the input values.

In addition, through this, the computing system 1000 can help identify and avoid abnormal input values, thereby improving the success rate and prediction accuracy of the molecular generation model and increasing its reliability and stability.

In addition, through this, the computing system 1000 can contribute to continuous performance improvement of the molecular generation model by inducing effective data supplementation and re-learning.

Accordingly, the computing system 1000 provides the multi-tasking model that generates and outputs molecules in a form that further guarantees physical/scientific validity, thereby directly and significantly improving the quality of the service processes such as experimental verification based on this.

The method for providing a guide to support the performance improvement of the multi-tasking model according to one embodiment of the present disclosure and the system thereof may quantitatively evaluate the validity of input data of a multi-tasking model and provide a guide accordingly, thereby identifying and avoiding abnormal input values, increasing the prediction performance and generation success rate of the multi-tasking model, and improving its reliability and accuracy.

In addition, the method and system for providing a guide to support the performance improvement of a multi-tasking model according to one embodiment of the present disclosure can support continuous improvement of the multi-tasking model by securing diversity of data through effective data supplementation and re-learning.

In addition, the method and system for providing a guide to support performance improvement of a multi-tasking model according to one embodiment of the present disclosure have the effect of easily securing physical or scientific validity for the output of the multi-tasking model.

In addition, the method for providing the guide and the system thereof that support the performance improvement of the multi-tasking model according to one embodiment of the present disclosure can quantitatively evaluate the validity of input data of the multi-tasking model by utilizing various deep learning algorithms, thereby improving evaluation accuracy and reliability through multi-faceted analysis.

In addition, the method for providing a guide and the system thereof that support the performance improvement of the multi-tasking model according to one embodiment of the present disclosure can provide a more intuitive and clearer guide by visualizing the guide according to the quantitative evaluation results, thereby further enhancing user understanding and satisfaction.

Meanwhile, according to an embodiment, the computing system 1000 may further implement the following additional service configuration based on the multi-tasking learning model (MtLM) trained according to an embodiment of the present disclosure in order to increase the operational convenience and flexibility of the multi-tasking model guide provision service.

As an example, the computing system 1000 may implement a service that provides real-time monitoring and notification when the physical property input information or the validity index exceeds or falls below a preset threshold.

For example, the computing system 1000 can provide a service that supports improving the speed of an on-site response by immediately notifying users of a “safety standard failure” or “quality standard failure” status through a web dashboard or mobile push notification and providing specific guidance on necessary follow-up actions.

In another embodiment, the computing system 1000 may implement a service that automatically generates and/or distributes customized reports based on predetermined periods or events.

For example, a service may be provided that automatically creates a PDF or PPT report summarizing the trend of the validity index and the effect of applying the physical property guide for each project on a weekly basis and uploads the PDF or PPT report to email or a shared drive, so that it can be used immediately as material for internal meetings.

In another embodiment, the computing system 1000 may implement a service that can be linked with external systems (for example, ERP, MES, and/or LIMS) through a RESTful API and a Webhook interface.

Through this, the computing system 1000 may provide the application service based on the multi-tasking learning model (MtLM) that is seamlessly integrated into internal and external business workflows, such as automatically performing a validity analysis when inputting new product physical property data or reflecting prediction results in real time by linking with a logistics and/or manufacturing process management system.

In another embodiment, the computing system 1000 may implement a service that supports immediate retrieval of the physical property input information and guides by simply scanning an identification code (for example, QR code, or the like) provided through a predetermined application, and utilization of cached prediction results even in an environment where the network is unstable.

Accordingly, the computing system 1000 may provide advantages of increasing user accessibility to data and/or information of application services based on the multi-tasking learning model (MtLM) and accelerating decision-making speed.

In another embodiment, the computing system 1000 may implement a service that supports a “What-if” interactive tuning workflow.

That is, the computing system 1000 may provide a service that allows a user to adjust hyperparameters (for example, a learning rate and/or batch size, or the like) and immediately visually check the change in the validity index according to the physical property input information.

Accordingly, the computing system 1000 can provide an application service based on the multi-tasking learning model (MtLM) that can easily search for optimal model settings.

In another embodiment, the computing system 1000 may implement a service that automates model improvement through a user feedback loop.

For example, when the computing system 1000 receives field verification data for the final generated molecular structure from a user, the computing system 1000 integrates the data into a data set for re-learning and provides a notification when re-learning is recommended, thereby providing a service for continuously improving the accuracy and reliability of the model.

In another embodiment, the computing system 1000 may implement a service that supports collaboration and sharing functions among the plurality of users, thereby enabling the plurality of researchers and/or engineers to jointly review and discuss prediction results and guides of the same project.

In another embodiment, the computing system 1000 may implement a service that provides cloud-based batch processing and scheduling capabilities.

For example, the computing system 1000 may provide an application service based on the multi-tasking learning model (MtLM) that maximizes the efficiency of repetitive tasks by automatically analyzing a large amount of physical property input data according to a specified time or cycle and monitoring the processing status and failure logs using a dashboard.

In another embodiment, the computing system 1000 may implement a service that generates and hosts predetermined educational and/or onboarding content.

For example, the computing system 1000 may provide an application service based on the multi-tasking learning model (MtLM) that supports even non-experts to easily utilize the model by providing video tutorials and interactive manuals including model usage instructions, physical property analysis guides, and/or precautions.

The pre-training method and system for a multi-tasking model according to one embodiment of the present disclosure perform transfer learning through the geometric alignment in the integrated latent space for multiple tasks according to the plurality of domains, thereby accurately predicting an integrated output that satisfies each requirement according to the plurality of domains.

In addition, the pre-training method and system for a multi-tasking model according to one embodiment of the present disclosure can simultaneously train various prediction tasks according to the plurality of domains in the transfer learning process, thereby learning not only individual principles of each domain but also correlations between domains and common principles for the entire domain, and expanding the model learning area and expanding the prediction acceptance range for each domain and domain at the same time.

Accordingly, the pre-training method and system for a multi-tasking model according to one embodiment of the present disclosure may directly improve the performance and quality of processing various multi-tasking tasks using the trained model.

In addition, the pre-training method and system for a multi-tasking model according to one embodiment of the present disclosure can easily support the transfer of knowledge between interrelated data and the improvement of prediction performance accordingly by implementing the exchange of mutual information by matching geometric properties between the various prediction tasks.

In addition, the pre-training method and system for a multi-tasking model according to one embodiment of the present disclosure may increase resistance to unnecessary interference information and increase the stability of the model.

In addition, the pre-training method and system for a multi-tasking model according to one embodiment of the present disclosure can increase the diversity of data used for model learning and improve learning performance by allowing the model to train more information by securing a data set for training using source data from various sources.

In addition, the pre-training method and system for a multi-tasking model thereof according to one embodiment of the present disclosure can predict the plurality of physical properties for a specific material by applying the multi-tasking learning model (MtLM) trained as described above to predict relationships between the plurality of physical properties and materials, thereby providing a multi-tasking model capable of predicting a specific material satisfying the plurality of physical properties, providing a multi-tasking model that can be universally utilized for various materials or subject matters, and having the effect of improving the quality of the entire related industry.

The pre-training method and system for a multi-tasking model according to one embodiment of the present disclosure can provide the multi-tasking model that maintains high performance for multiple tasks even on a small data set by solving the problem of insufficient data by transferring knowledge trained from the source task to the target task through the transfer learning.

Therefore, the pre-training method and system for a multi-tasking model according to one embodiment of the present disclosure can effectively expand the scope of application to fields where it is difficult to apply machine learning models due to insufficient data or domain knowledge.

In addition, the pre-training method and system for a multi-tasking model according to one embodiment of the present disclosure provide a specialized transfer learning technique that can be effectively applied to regression problems, thereby demonstrating high prediction performance even in complex regression problems such as molecular data sets.

In addition, the pre-training method and system for a multi-tasking model according to one embodiment of the present disclosure can improve the efficiency of transfer learning by maintaining geometric consistency between tasks by optimizing knowledge transfer between the source task and the target task through the Riemannian geometric approach.

In addition, the pre-training method and system for a multi-tasking model according to one embodiment of the present disclosure may improve the generalization performance of the model by combining the plurality of loss functions to regularize various aspects of the model.

Meanwhile, the embodiments according to the present disclosure described above may be implemented in the form of program commands that can be executed through various computer components and recorded on a computer-readable recording medium. The computer-readable recording medium may include program commands, data files, data structures, or the like, alone or in combination. The program commands recorded on the computer-readable recording medium may be those specially designed and configured for the present disclosure or those known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program commands, such as ROMs, RAMs, and flash memories. Examples of the program commands include not only machine language codes generated by a compiler, but also high-level language codes that can be executed by a computer using an interpreter, or the like. The hardware devices may be changed into one or more software modules to perform processing according to the present disclosure, and vice versa.

The specific implementations described in the present disclosure are only exemplary embodiments and do not limit the scope of the present disclosure in any way. For the sake of brevity of the specification, descriptions of conventional electronic configurations, control systems, software, and other functional aspects of the systems may be omitted. In addition, the connections or lack of connections of lines between components illustrated in the drawings are merely exemplary of functional connections and/or physical or circuit connections, and may be replaced or represented as various additional functional connections, physical connections, or circuit connections in an actual device. In addition, when there is no specific mention such as “essential,” “important,” or the like, it may not be a component absolutely necessary for the application of the present disclosure.

In addition, although the detailed description of the present disclosure has been described with reference to preferred embodiments of the present disclosure, it will be understood by those skilled in the art or having common knowledge in the art that various modifications and changes can be made to the present disclosure without departing from the spirit and technical scope of the present disclosure as described in the claims below. Accordingly, the technical scope of the present disclosure should not be limited to the contents described in the detailed description of the specification, but should be defined by the claims.

What is claimed is:

1. A method for pre-training a multi-tasking model by a computing system including memory and one or more processors, the method comprising:
acquiring experimental data including material-specific characteristic information, which specifies characteristics of a material, and material-physical property specific information, which specifies characteristic values for a plurality of physical properties of the material;
simultaneously training a plurality of tasks for predicting the characteristic values for the plurality of physical properties based on the acquired experimental data in the multi-tasking model; and
providing the trained multi-tasking model,
wherein the simultaneous training of the plurality of tasks includes simultaneously training the plurality of tasks based on n task processing units (n≥2), each including a task processing unit configured to process a plurality of sub-tasks for predicting a characteristic value for each physical property.

2. The method of claim 1, wherein at least one of the n task processing units includes:
an encoder module configured to map a feature vector of a first task to a first latent space corresponding to the first task,
a transfer module configured to map the feature vector of the first task, mapped to the first latent space, to a second latent space corresponding to a second task through an integrated latent space shared by the plurality of tasks, and
an inverse transfer module configured to re-map the feature vector of the first task, mapped to the second latent space, to the first latent space.

3. The method of claim 2, wherein the task processing unit further includes a head module configured to generate a prediction value according to the feature vector of the first task.

4. The method of claim 2, wherein the integrated latent space is a virtual space that matches geometric properties of a plurality of feature vectors between the plurality of tasks.

5. The method of claim 4, wherein the simultaneous training of the plurality of tasks based on the n task processing units includes:
mapping each of the plurality of feature vectors of each of the plurality of tasks to each of a plurality of latent spaces corresponding to each of the plurality of tasks, and
geometrically aligning the plurality of feature vectors mapped to the plurality of latent spaces through the integrated latent space.

6. The method of claim 5, wherein the geometrically aligning of the plurality of feature vectors includes:
acquiring a geometric alignment vector supporting geometric alignment in the integrated latent space, based on the acquired experimental data,
calculating a geometric alignment loss based on the acquired geometric alignment vector, and
updating one or more parameters of the multi-tasking model based on the calculated geometric alignment loss.

7. The method of claim 6, wherein the simultaneous training of the plurality of tasks based on the n task processing units further includes simultaneously performing the geometric alignment for n*n combinations of the plurality of physical properties.

8. The method of claim 7, wherein the simultaneous performing of the geometric alignment includes simultaneously performing the geometric alignment by applying a same transformation method to each of the n*n combinations of the plurality of physical properties.

9. The method of claim 6, wherein the acquiring of the experimental data includes acquiring physical property relationship information, which specifies a relationship between the plurality of physical properties, based on prompt engineering based on a pre-trained language model.

10. The method of claim 9, wherein the physical property relationship information includes information specifying physical properties related to a predetermined physical property, information specifying an attribute of a relationship between the related physical properties, and information specifying an association degree according to the attribute of the relationship.

11. The method of claim 9, wherein the calculating of the geometric alignment loss includes adjusting a weight of the geometric alignment loss based on the physical property relationship information.

12. The method of claim 1, wherein the providing of the trained multi-tasking model includes providing a service configured to, when a molecular structure formula is input to the trained multi-tasking model, output a plurality of domain-specific physical property values that have been pre-trained in the trained multi-tasking model based on the input molecular structure formula.

13. The method of claim 1, wherein the providing of the trained multi-tasking model includes:
reverse-engineering the trained multi-tasking model, and
providing a service configured to, when a physical property value for a predetermined physical property is input to the reverse-engineered multi-tasking model, output at least one molecular structural formula satisfying the input physical property value for the predetermined physical property.

14. The method of claim 1, wherein the providing of the trained multi-tasking model includes acquiring first input information specifying a predetermined domain characteristic, acquiring a validity index, which is data that quantitatively specifies generation difficulty of output data of the multi-tasking model according to the acquired first input information, generating first guide information, which is data that specifies domain characteristic that reduces the generation difficulty based on the acquired validity index, and providing the generated first guide information.

15. The method of claim 14, wherein the providing of the trained multi-tasking model further includes generating second guide information, which is data that specifies a model training method that reduces the generation difficulty based on the acquired validity index, and providing the generated second guide information.

16. The method of claim 15, wherein the providing of the trained multi-tasking model further includes:
acquiring second input information specifying domain characteristics,
acquiring updated information that is data replacing the acquired first input information based on the acquired second input information, and
providing the first guide information according to the acquired updated information and/or the second guide information according to the acquired updated information.

17. A system for pre-training a multi-tasking model, the system comprising:
memory; and
one or more processors configured to perform the pre-training for the multi-tasking model by reading out at least one application stored in the memory,
wherein the one or more processors are configured to execute instructions comprising:
acquiring experimental data including material-specific characteristic information, which specifies characteristics of a material, and material-physical property specific information, which specifies characteristic values for a plurality of physical properties of the material,
simultaneously training a plurality of tasks for predicting the characteristic values for the plurality of physical properties based on the acquired experimental data in the multi-tasking model, and
providing the trained multi-tasking model,
wherein the simultaneous training of the plurality of tasks includes simultaneously training the plurality of tasks based on n task processing units (n≥2), each including a task processing unit configured to process a plurality of sub-tasks for predicting a characteristic value for each physical property.
